(19) United States
(12) Patent Application Publication
(10) Pub. No.: US 2021/0374717 A1
(43) Pub. Date: Dec. 2, 2021

(54) TERMINAL AND OPERATING METHOD THEREFOR

(71) Applicant: LG ELECTRONICS INC., Seoul (KR)

(72) Inventors: Jie SEOL, Seoul (KR); Joowoo LEE, Seoul (KR); Soomin KIM, Seoul (KR); Minsoo BYUN, Seoul (KR)

(73) Assignee: LG ELECTRONICS INC., Seoul (KR)

(21) Appl. No.: 16/322,455

(22) PCT Filed: Oct. 14, 2016
(86) PCT No.: PCT/KR2016/011526

§ 371 Date: Jan. 31, 2019

(30) Foreign Application Priority Data
Aug. 4, 2016 (KR) 10-2016-0099341

(51) Int. Cl. G06Q 20/34

(52) U.S. Cl. CPC G06Q 20/34

(57) ABSTRACT

The present invention relates to a terminal and an operating method therefor. The terminal executes a payment function in a first screen mode in which a screen direction of the terminal is a first direction, and can display a default payment card image corresponding to the executed payment function. The terminal transmits card information corresponding to the displayed default payment card image and can recognize that the first screen mode is changed to a second screen mode in which the screen direction of the terminal is a second direction. The terminal can execute an additional function related to a payment according to the transmitted card information in the second screen mode.

### TECHNICAL FIELD

The present invention relates to a terminal and control method thereof, and more particularly, to a terminal providing a payment function and control method thereof.

### BACKGROUND ART

Terminals may be generally classified as mobile/portable terminals or stationary terminals according to their mobility. Mobile terminals may also be classified as handheld terminals or vehicle mounted terminals according to whether or not a user can directly carry the terminal.

A mobile terminal is a device which may be configured to perform various functions. Examples of such functions include data and voice communications, capturing images and video via a camera, recording audio, playing music files and outputting music via a speaker system, and displaying images and video on a display. Some terminals include additional functionality which supports game playing, while other terminals are also configured as multimedia players. More recently, mobile terminals have been configured to receive broadcast and multicast signals which permit viewing of contents, such as videos and television programs.

Some mobile terminals include additional functionality which supports game playing, while other terminals are configured as multimedia players. More recently, mobile terminals have been configured to receive broadcast and multicast signals which permit viewing of content such as videos and television programs.

To support and increase the mobile terminal functions, it may be able to consider the improvement of structural parts and/or software parts of the mobile terminal.

Recently, various financial services using terminals are provided.

A so-called ‘fintech’ is a mixed word using finance and technology, and indicates a combined service of finance and IT or a company providing such a service. A most actively expanding field of fintech is a payment field of making a payment for goods or service by transmitting card information stored in a terminal through the terminal.

Since a payment method by terminal has the convenience of not carrying a real card and the security of not exposing a card number and personal information such as card user's name, it is estimated as becoming a future payment means.

### DISCLOSURE OF THE INVENTION

### Technical Task

One technical task of the present invention is to provide a payment function suing a terminal.

Another technical task of the present invention is to provide a payment function using a terminal having an intuitive and convenient manipulation mechanism.

Further technical task of the present invention is to provide a payment function using a plurality of display regions.

### Technical Solutions

In one technical aspect of the present invention, provided herein is a method of operating a terminal, the method including executing a payment function in first screen mode having a terminal's screen direction set to a first direction, displaying a default payment card image corresponding to the executed payment function, transmitting card information corresponding to the displayed default payment card image, recognizing that the first screen mode is switched to a second screen mode having the terminal's screen direction set to a second direction, and performing an additional function related to a payment according to the transmitted card information in the second screen mode.

The performing the additional function related to the payment may include outputting a payment breakdown according to the transmitted card information.

The performing the additional function related to the payment may include performing an additional payment further including at least one of accumulation and discount related to the payment.

The performing the additional function related to the payment may include sharing information on a payment breakdown according to the transmitted card information.

The first screen mode may include a portrait mode and the second screen mode may include a landscape mode.

In another technical aspect of the present invention, provided herein is a method of operating a terminal, the method including obtaining an input of selecting at least one card image displayed on a sub-display region in first screen mode having a terminal's screen direction set to a first direction, displaying card information corresponding to the selected at least one card image on a main display region, recognizing that the first screen mode is switched to a second screen mode having the terminal's screen direction set to a second direction, and performing a payment function related to the card information displayed on the main display region in the second screen mode.

The performing the payment function related to the card information may include transmitting the card information to a different device.

The performing the payment function related to the card information may include obtaining a detailed setting input for a payment using the card information and performing the payment according to the obtained detailed setting input.

The performing the payment function related to the card information may include outputting a payment breakdown related to the card information.

The first screen mode may include a landscape mode and the second screen mode may include a portrait mode.

In further technical aspect of the present invention, provided herein is a terminal, including a memory, a display unit, a wireless communication unit transmitting card information, a sensing unit sensing a terminal's screen direction, and a controller configured to execute a payment function in first screen mode having the terminal's screen direction set to a first direction, display a default payment card image corresponding to the executed payment function on the display unit, transmit card information corresponding to the displayed default payment card image through the wireless communication unit, recognize that the first screen mode is switched to a second screen mode having the terminal's screen direction set to a second direction based on a sensing value of the sensing unit, and perform an additional function related to a payment according to the transmitted card information in the second screen mode.

The controller may output a payment breakdown according to the transmitted card information in the second screen mode.

The controller may perform an additional payment further including at least one of accumulation and discount related to the payment in the second screen mode.

The controller may share information on a payment breakdown according to the transmitted card information.

The first screen mode may include a portrait mode and the second screen mode may include a landscape mode.

In another further technical aspect of the present invention, provided herein is a terminal, including a memory, a display unit including a main display region and a sub-display region, a wireless communication unit transmitting card information, a sensing unit sensing a terminal's screen direction, and a controller configured to obtain an input of selecting at least one card image displayed on the sub-display region in first screen mode having a terminal's screen direction set to a first direction, display card information corresponding to the selected at least one card image on the main display region, recognize that the first screen mode is switched to a second screen mode having the terminal's screen direction set to a second direction based on a sensing value of the sensing unit, and perform a payment function related to the card information displayed on the main display region in the second screen mode.

The controller may transmit the card information to a different device through the wireless communication unit in the second screen mode.

The controller may obtain a detailed setting input for a payment using the card information in the second screen mode and performs the payment according to the obtained detailed setting input.

The controller may output a payment breakdown related to the card information in the second screen mode.

The first screen mode may include a landscape mode and the second screen mode may include a portrait mode.

### Advantageous Effects

A terminal according to an embodiment of the present invention can switch a payment function in response to a mode switching of the terminal or provide an additional function, thereby providing an intuitive and convenient payment interface.

Moreover, the present invention can provide a payment function suing a plurality of display regions, thereby utilizing a plurality of displays or a plurality of display regions in a payment function.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### DESCRIPTION OF DRAWINGS

FIG. 1 is a block diagram to describe a terminal related to the present invention.

FIG. 2 is an exemplary diagram of a terminal related to the present invention.

FIG. 3 is a flowchart for an operating method of a terminal according to various embodiments of the present invention.

FIG. 4 is an exemplary diagram of a payment and receipt display operation according to various embodiments of the present invention.

FIG. 5 is an exemplary diagram of a payment and receipt display operation over a predetermined amount according to various embodiments of the present invention.

FIG. 6 is an exemplary diagram for a cumulative amount display according to various embodiments of the present invention.

FIG. 7 is an exemplary diagram for a cumulative amount display effect according to various embodiments of the present invention.

FIG. 8 is an exemplary diagram for a transportation card payment according to various embodiments of the present invention.

FIG. 9 is an exemplary diagram for a payment change according to various embodiments of the present invention.

FIG. 10 is an exemplary diagram for a payment change according to various embodiments of the present invention.

FIG. 11 is an exemplary diagram for a discount/accumulation applied payment according to various embodiments of the present invention.

FIG. 12 is an exemplary diagram for a discount/accumulation applied payment according to various embodiments of the present invention.

FIG. 13 is an exemplary diagram for an SNS upload of a payment breakdown according to various embodiments of the present invention.

FIG. 14 is an exemplary diagram for a payment breakdown sharing and an amount settlement message transmission according to various embodiments of the present invention.

FIG. 15 is an exemplary diagram for a settlement amount transfer according to various embodiments of the present invention.

FIG. 16 is an exemplary diagram for a settlement amount payment according to various embodiments of the present invention.

FIG. 17 is a flowchart for a payment operation according to various embodiments of the present invention.

FIG. 18 is an exemplary diagram for a payment operation according to various embodiments of the present invention.

FIG. 19 is a flowchart for a payment function executing operation according to various embodiments of the present invention.

FIG. 20 is an exemplary diagram for a payment operation according to various embodiments of the present invention.

FIG. 21 is an exemplary diagram for a payment operation according to various embodiments of the present invention.

FIG. 22 is an exemplary diagram for an installment period setting according to various embodiments of the present invention.

FIG. 23 is an exemplary diagram for a recent payment breakdown according to various embodiments of the present invention.

FIG. 24 is an exemplary diagram for a tip payment according to various embodiments of the present invention.

FIG. 25 is an exemplary diagram for a detailed card information display according to various embodiments of the present invention.

FIG. 26 is an exemplary diagram for a compound payment according to various embodiments of the present invention.

FIG. 27 is an exemplary diagram for a card category change display according to various embodiments of the present invention.

FIG. 28 is an exemplary diagram for a payment using a plurality of cards according to various embodiments of the present invention.

FIG. 29 is an exemplary diagram for a card information display according to various embodiments of the present invention.

FIG. 30 and FIG. 31 are exemplary diagrams for a card image arrangement in a sub-display region according to various embodiments of the present invention.

FIG. 32 is an exemplary diagram for a card image display in a prescribed partitioned region according to various embodiments of the present invention.

FIG. 33 is a diagram showing a partitioned region maintained screen according to various embodiments of the present invention.

FIG. 34 is an exemplary diagram for a card image display on a prescribed partitioned region according to various embodiments of the present invention.

FIG. 35 is an exemplary diagram for a partitioned region removal according to various embodiments of the present invention.

FIG. 36 is an exemplary diagram for a partitioned region display according to various embodiments of the present invention.

### BEST MODE FOR INVENTION

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, and the like.

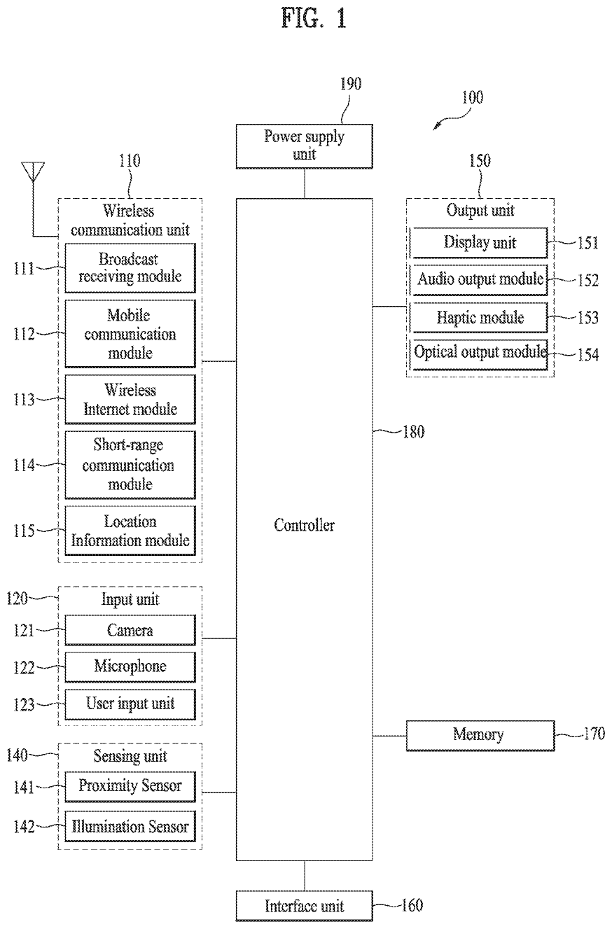

Reference is now made to FIG. 1, where FIG. 1 is a block diagram of a terminal in accordance with the present disclosure.

The mobile terminal 100 is shown having components such as a wireless communication unit 110, an input unit 120, a sensing unit 140, an output unit 150, an interface unit 160, a memory 170, a controller 180, and a power supply unit 190. It is understood that implementing all of the illustrated components is not a requirement, and that greater or fewer components may alternatively be implemented.

For instance, the wireless communication unit 110 typically includes one or more components which permit wireless communication between the mobile terminal 100 and a wireless communication system or network within which the mobile terminal is located.

The wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, and the like) for allowing a user to input information. Data (for example, audio, image, and the like) is obtained by the input unit 120 and may be analyzed and processed by controller 180 according to user commands thereof.

The sensing unit 140 is typically implemented using one or more sensors configured to sense internal information of the mobile terminal, the surrounding environment of the mobile terminal, user information, and the like. For example, in FIG. 1, the sensing unit 140 may include at least one of a proximity sensor 141, an illumination sensor 142, a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154. The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 may provide or process information or functions appropriate for a user by processing signals, data, information and the like, which are input or output by the various components depicted in FIG. 1, or activating application programs stored in the memory 170.

Moreover, the controller 180 controls some or all of the components illustrated in FIG. 1 according to the execution of an application program that have been stored in the memory 170.

The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

At least some of the above components can cooperatively operate to implement operations, controls and controlling methods of the mobile terminal according to various embodiments described in the following. The operations, controls or controlling methods of the mobile terminal can be implemented on the mobile terminal by running at least one application program saved to the memory 170.

Referring still to FIG. 1, various components depicted in this figure will now be described in more detail.

Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

The broadcast managing server generally refers to a server which generates and transmits a broadcast signal and/or broadcast associated information or a server which is provided with a previously generated broadcast signal and/or broadcast associated information and then transmits the provided signal or information to a terminal. The broadcast signal may be implemented as a TV broadcast signal, a radio broadcast signal, and a data broadcast signal, among others. If desired, the broadcast signal may further include a broadcast signal combined with a TV or radio broadcast signal.

The broadcast signal may be encoded according to any of a variety of technical standards or broadcasting methods (for example, International Organization for Standardization (ISO), International Electro technical Commission (IEC), Digital Video Broadcast (DVB), Advanced Television Systems Committee (ATSC), and the like) for transmission and reception of digital broadcast signals. The broadcast receiving module 111 can receive the digital broadcast signals using a method appropriate for the transmission method utilized.

The broadcast associated information includes information associated with a broadcast channel, a broadcast program, a broadcast service provider, etc. And, the broadcast associated information can be provided via a mobile communication network. In this case, the broadcast associated information can be received by the mobile communication module 112.

The broadcast associated information can be implemented in various forms. For instance, broadcast associated information may include an electronic program guide (EPG) of digital multimedia broadcasting (DMB) and electronic service guide (ESG) of digital video broadcast-handheld (DVB-H).

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE), LTE-A (Long Term Evolution-Advanced), and the like).

Examples of wireless signals transmitted and/or received via the mobile communication module 112 include audio call signals, video (telephony) call signals, or various formats of data to support communication of text and multimedia messages.

The wireless Internet module 113 is configured to facilitate wireless Internet access. This module may be internally or externally coupled to the mobile terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), and the like. The wireless Internet module 113 may transmit/receive data according to one or more of such wireless Internet technologies, and other Internet technologies as well.

In some embodiments, when the wireless Internet access is implemented according to, for example, WiBro, HSDPA, HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi) and Wi-Fi Direct, and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

Moreover, the short range communication module 114 may transmit a magnetic signal. For example, the short range communication module 114 can transmit a magnetic signal containing card information. The short range communication module 114 can include a Magnetic Secure Transmission (MST) module. And, the MST module can transmit a Magnetic Secure Transmission (MST) signal.

In some embodiments, another mobile terminal (which may be configured similarly to mobile terminal 100) may be a wearable device, for example, a smart watch, a smart glass or a head mounted display (HMD), which is able to exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the controller 180, for example, may cause transmission of data processed in the mobile terminal 100 to the wearable device via the short-range communication module 114. Hence, a user of the wearable device may use the data processed in the mobile terminal 100 on the wearable device. For example, when a call is received in the mobile terminal 100, the user may answer the call using the wearable device. Also, when a message is received in the mobile terminal 100, the user can check the received message using the wearable device.

The location information module 115 is generally configured to detect, calculate, derive or otherwise identify a position of the mobile terminal. As an example, the location information module 115 includes a Global Position System (GPS) module, a Wi-Fi module, or both. As one example, when the mobile terminal uses a GPS module, a position of the mobile terminal may be acquired using a signal sent from a GPS satellite. As another example, when the mobile terminal uses the Wi-Fi module, a position of the mobile terminal can be acquired based on information related to a wireless access point (AP) which transmits or receives a wireless signal to or from the Wi-Fi module.

The input unit 120 may be configured to permit various types of input to the mobile terminal 120. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the mobile terminal 100. As another example, the cameras 121 may be located in a stereoscopic arrangement to acquire left and right images for implementing a stereoscopic image.

The microphone 122 is generally implemented to permit audio input to the mobile terminal 100. The audio input can be processed in various manners according to a function being executed in the mobile terminal 100. If desired, the microphone 122 may include assorted noise removing algorithms to remove unwanted noise generated in the course of receiving the external audio.

The user input unit 123 is a component that permits input by a user. Such user input may enable the controller 180 to control operation of the mobile terminal 100. The user input unit 123 may include one or more of a mechanical input element (for example, a key, a button located on a front and/or rear surface or a side surface of the mobile terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the mobile terminal at a location that is other than the touch screen. On the other hand, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like. The controller 180 generally cooperates with the sending unit 140 to control operation of the mobile terminal 100 or execute data processing, a function or an operation associated with an application program installed in the mobile terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this case, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like). In general, controller 180 processes data corresponding to proximity touches and proximity touch patterns sensed by the proximity sensor 141, and cause output of visual information on the touch screen. In addition, the controller 180 can control the mobile terminal 100 to execute different operations or process different data according to whether a touch with respect to a point on the touch screen is either a proximity touch or a contact touch.

A touch sensor can sense a touch applied to the touch screen, such as display unit 151, using any of a variety of touch methods. Examples of such touch methods include a resistive type, a capacitive type, an infrared type, and a magnetic field type, among others.

As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 may sense which region of the display unit 151 has been touched. Here, the touch controller may be a component separate from the controller 180, the controller 180, and combinations thereof.

In some embodiments, the controller 180 may execute the same or different controls according to a type of touch object that touches the touch screen or a touch key provided in addition to the touch screen. Whether to execute the same or different control according to the object which provides a touch input may be decided based on a current operating state of the mobile terminal 100 or a currently executed application program, for example.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121 typically includes at least one a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

In some embodiments, the display unit 151 may be implemented as a stereoscopic display unit for displaying stereoscopic images.

A typical stereoscopic display unit may employ a stereoscopic display scheme such as a stereoscopic scheme (a glass scheme), an auto-stereoscopic scheme (glassless scheme), a projection scheme (holographic scheme), or the like.

In general, a 3D stereoscopic image may include a left image (e.g., a left eye image) and a right image (e.g., a right eye image). According to how left and right images are combined into a 3D stereoscopic image, a 3D stereoscopic imaging method can be divided into a top-down method in which left and right images are located up and down in a frame, an L-to-R (left-to-right or side by side) method in which left and right images are located left and right in a frame, a checker board method in which fragments of left and right images are located in a tile form, an interlaced method in which left and right images are alternately located by columns or rows, and a time sequential (or frame by frame) method in which left and right images are alternately displayed on a time basis.

Also, as for a 3D thumbnail image, a left image thumbnail and a right image thumbnail can be generated from a left image and a right image of an original image frame, respectively, and then combined to generate a single 3D thumbnail image. In general, the term “thumbnail” may be used to refer to a reduced image or a reduced still image. A generated left image thumbnail and right image thumbnail may be displayed with a horizontal distance difference there between by a depth corresponding to the disparity between the left image and the right image on the screen, thereby providing a stereoscopic space sense.

A left image and a right image required for implementing a 3D stereoscopic image may be displayed on the stereoscopic display unit using a stereoscopic processing unit. The stereoscopic processing unit can receive the 3D image and extract the left image and the right image, or can receive the 2D image and change it into a left image and a right image.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

A signal output by the optical output module 154 may be implemented in such a manner that the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various informations for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal there through. Various command signals or power input from the cradle may operate as signals for recognizing that the mobile terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc.), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The controller 180 may typically control the general operations of the mobile terminal 100. For example, the controller 180 may set or release a lock state for restricting a user from inputting a control command with respect to applications when a status of the mobile terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 receives external power or provides internal power and supply the appropriate power required for operating respective elements and components included in the mobile terminal 100. The power supply unit 190 may include a battery, which is typically rechargeable or be detachably coupled to the terminal body for charging.

The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Various embodiments described herein may be implemented in a computer-readable medium, a machine-readable medium, or similar medium using, for example, software, hardware, or any combination thereof.

A terminal according to various embodiments of the present invention can include a plurality of display regions or a plurality of displays and recognize biometric information such as fingerprints. And, the terminal may transmit such information related to a payment as card information.

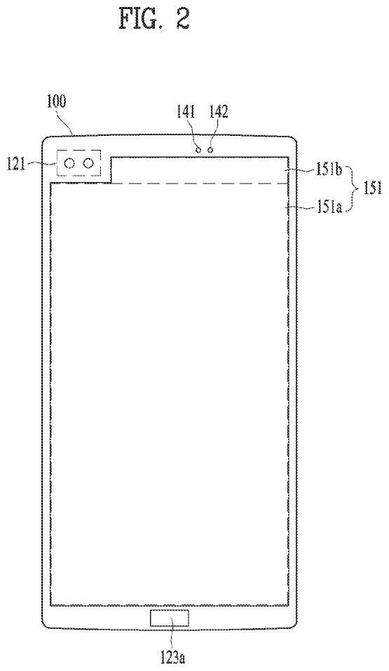

An exterior of a terminal according to various embodiments of the present invention shall be described with reference to FIG. 2 as follows.

FIG. 2 is the conceptual diagram of one example of a terminal related to the present invention, viewed in front.

Referring to FIG. 2, a camera 121, a manipulating unit 123a, a proximity sensor 141, an illumination sensor 142 and a display unit 151 can be disposed on a front side of a terminal 100.

The camera 121 processes video frames of still or moving images obtained by an image sensor in shooting or video call mode.

The camera 121 may include a plurality of cameras. For example, a first camera and a second camera can be included. The first camera and the second camera may have different view angles.

The manipulating unit 123a is one example of a user input unit 123 manipulated to receive an input of a command for controlling an operation of the terminal 100, and may be commonly called a manipulating portion. The manipulating unit 123a can employ any manner that is a tactile manner (e.g., touch, push, scroll, etc.) for a user to perform manipulation with tactile feelings. Moreover, the manipulating unit 123a may employ a manner of performing manipulation through a proximity touch, a hovering touch or the like without user's tactile feelings.

In the preset drawing, the manipulating unit 123a is illustrated as a touch key, by which the present invention is non-limited. For example, the manipulating unit 123a may include a push key (e.g., a mechanical key) or a combination of a touch key and a push key.

In some implementations, the manipulating unit 123a may include a built-in fingerprint recognition sensor capable of recognizing user's fingerprints. Therefore, the terminal 100 can recognize a user's fingerprint coming in contact with the manipulating unit 123a.

The manipulating unit 123a may be disposed on a rear side of the terminal 100. And, the manipulating unit 123a may include a plurality of manipulating units disposed on the front and rear sides of the terminal 100, respectively.

As the proximity sensor 141 and the illumination 142 sensor are described above, they shall not be described in the following.

The display unit 151 displays (outputs) information processed by the mobile terminal 100. For example, the display unit 151 can display running screen information of an application program running in the mobile terminal 100 or User Interface (UI) or Graphic User Interface (GUI) information according to the running screen information.

The display unit 151 can have a main display region 151a and a sub-display region 151b. As one embodiment, the display unit 151 can include a single display having a plurality of display regions, e.g., a main display region 151a and a sub-display region 151b. As another embodiment, the display unit 151 can have a plurality of display modules such as a first display module corresponding to the main display region 151a and a second display module corresponding to the sub-display region 151b. Each of the main display region 151a and the sub-display region 151b may be turned on/off individually and display different information.

In some implementations, the display unit 151 may have a built-in fingerprint recognition sensor. Therefore, the terminal 100 can recognize a user's fingerprint coming in contact with a prescribed region of the display unit 151.

A terminal according to various embodiments of the present invention can transmit a signal related to a payment to another device. The terminal can perform an additional function related to a payment according to a screen mode switching of the terminal. Here, the screen mode switching may mean a switching between a landscape mode and a portrait mode or a rotation mode according to a rotation of the terminal. This shall be described in detail as follows.

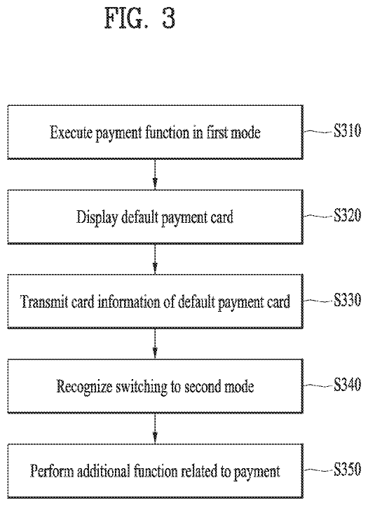

FIG. 3 is a flowchart for an operating method of a terminal according to various embodiments of the present invention.

Referring to FIG. 3, the terminal 100 can execute a payment function in first mode [S310].

The controller 180 of the terminal 100 can execute the payment function capable of transmitting a payment signal in the first mode. For example, the controller 180 can launch a payment application. Here, the first mode may include a screen mode of the terminal 100, e.g., a portrait mode or a landscape mode. For example, the first mode may mean the portrait mode of the terminal 100. Moreover, the first mode may include the landscape mode of the terminal 100.

Here, the payment signal may mean a signal including information of various cards such as a credit card, a prepaid card, a check card, a point card, a discount card and the like. Hence, a payment signal transmission of the terminal 100 may include a card information transmission.

As one embodiment, the controller 180 may execute a payment function based on at least one key input. For example, the controller 180 can execute a payment function based on an input of pushing the manipulating unit 123a. And, the controller 180 may execute a payment function based on fingerprint recognition using the manipulating unit 123a.

As another embodiment, the controller 180 may execute a payment function based on a signal transmitted from another device. For example, the terminal 100 can receive a signal related to a payment function from another device. As one embodiment, the terminal 100 can receive a payment information signal related to a payment function through NFC or Bluetooth communication. Here, the payment information signal transmitted from another device may be a signal for executing a payment function and include information on an available payment type and information on an item and amount to pay. And, the payment information signal transmitted from another device may include information related to a corresponding shop or store.

As another embodiment, the controller 180 may execute a payment function based on a touch input to the display unit 151. For example, if obtaining an input of swiping from a bottom end of the display unit 151 toward a top direction, the terminal 100 can execute a payment function.

As another embodiment, the controller 180 may execute a payment function based on shaking of the terminal. For example, the controller 180 can sense the shaking of the terminal through the sensing unit 140. If determining that the terminal is shaken in a preset pattern or with preset strength, the controller 180 can execute a payment function.

As further embodiment, if recognizing user's biometric information, the controller 180 may execute a payment function. For example, the controller 180 can recognize user's biometric information through a biometric recognition sensor included in the sensing unit 140. If recognizing the user's biometric information, the controller 180 may execute a payment function corresponding to the recognized user. Here, the user's biometric information recognized through the biometric recognition sensor may include various informations relevant to a user body such as fingerprint, iris and the like.

The terminal 100 can display a default payment card [S320].

If the payment function is executed, the controller 180 of the terminal 100 can display the default payment card on the display unit 151.

For example, the controller can display a card image of a default payment card on the display 151. The controller 180 may display card information of the default payment card on the display 151. Here, the default payment card may include a card configured to use basically by a user or a card most frequently used by a user.

For example, a user can set a payment card (e.g., a credit card) to use basically through a default payment card setting menu, and the set credit card may become a default payment card. For another example, the terminal 100 may set a payment card most frequently used by a user as a default payment card.

Based on a payment information signal received from another device, the terminal 100 may set a payment card corresponding to the payment information signal as a default payment card. For example, based on the received payment information signal, the controller 180 of the terminal 100 may set a payment card usable at a corresponding shop or a payment card most advantageous in case of using the payment card at the corresponding shop as a default payment card. Meanwhile, as a default payment card, various cards (e.g., check card, point card, prepaid card, etc.) capable of becoming payment means can be set as well as a credit card.

The terminal 100 can transmit card information of the default payment card [S330].

The controller 180 of the terminal 100 can transmit the card information of the displayed default payment card to another device that is a payment target. For example, the controller 180 can transmit the card information of the default payment card to Point Of Sale (POS) through the wireless communication unit 110.

As one embodiment, using the wireless communication unit 110, the controller 180 can transmit the card information of the default payment card to the POS using an NFC signal or a magnetic signal (e.g., MST signal). Through the wireless communication unit 110, the controller 190 may transmit the card information of the default payment card using both an NFC signal and a magnetic signal (e.g., MST signal).

As another embodiment, based on the received payment information signal, the controller 180 can transmit the card information of the default payment card using a signal that can be received by another device (e.g., POS) having transmitted the payment information signal.

The terminal 100 may recognize another device (e.g., POS) that will make payment and then transmit card information to the recognized POS. On the other hand, the terminal 100 may transmit card information in a predetermined distance while failing to recognize another device (e.g., POS) that will make payment.

The terminal 100 can recognize a switching to a second mode [S340].

Based on a sensing value of the sensing unit 140, the controller 180 of the terminal 100 can recognize that a screen mode of the terminal is switched to the second mode from the first mode.

For example, based on a sensing value sensed by at least one of an acceleration sensor, a magnetic sensor, a G-sensor, a gyroscope sensor and a motion sensor included in the sensing unit, the controller 180 can recognize a rotation state of the terminal. Hence, based on the sensing value of the sensing unit 140, the controller 180 can determine a screen mode of the terminal, e.g., a screen direction. Based on the determined screen direction, the controller 180 can recognize the switching of the screen mode. Particularly, the controller 180 can recognize that the terminal's screen direction is switched to a second screen mode (hereinafter named ‘second mode’) having the terminal's screen direction set to a second direction from a first screen mode (hereinafter named ‘first mode’) having the terminal's screen direction set to a first direction,

As one embodiment, if the first mode is the portrait mode, the controller 180 can recognize that the terminal's screen mode is switched from the portrait mode to the landscape mode based on the recognized rotation state.

As another embodiment, if the first mode is the landscape mode, the controller 180 can recognize that the terminal's screen mode is switched to the portrait mode from the landscape mode based on the recognized rotation state.

The terminal 100 can execute an additional function related to the payment.

If recognizing that the terminal is switched to the second mode from the first mode, controller 180 of the terminal 100 can perform the additional function related to the payment.

As one embodiment, if recognizing the mode switching, the controller 180 can output a detailed information on the made payment as the additional function related to the payment. For example, if recognizing the mode switching, the controller 180 can display a receipt for the made payment. For another example, if recognizing the mode switching, the controller 180 can output information on the payment breakdown for a predetermined period.

As another embodiment, if recognizing the mode switching, the controller 180 can share information on the made payment with another user or upload the information to SNS.

As another embodiment, if recognizing the mode switching, the controller 180 can additionally perform an additional payment (e.g., mileage accumulation, discount, etc.) related to the payment.

As further embodiment, the controller 180 can perform additional settings related to the payment. For example, the controller 180 receives an input of the settings for a compound payment using a plurality of payment cards and is then able to make an additional payment related to the made payment. For another example, the controller 180 may make an additional payment related to the made payment. Moreover, the controller 180 may cancel the made payment and then make a payment using a new payment card.

A detailed embodiment of the above-described operation is described as follows.

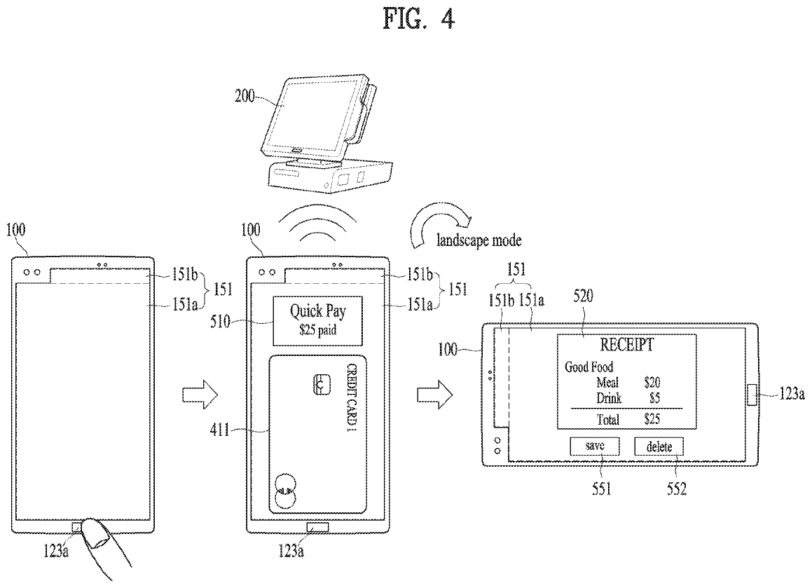

FIG. 4 is an exemplary diagram of a payment and receipt display operation according to various embodiments of the present invention.

Referring to FIG. 4, the controller 180 of the terminal 100 can recognize a user's fingerprint through the manipulating unit 123a in a first mode, e.g., a portrait mode. If recognizing the user's fingerprint, the controller 180 can execute a payment function and display a card image 411 of a default payment card, e.g., a first credit card on the display unit 151. The controller 180 can transmit card information of the first credit card corresponding to the displayed first credit card image 411 to a Point Of Sale (POS) 200. For example, through the wireless communication unit 110, the controller 180 can transmit the card information of the first credit card to the POS 200 using at least one of an NFC signal and an MST signal. The POS 200 can make payment based on the transmitted card information of the first credit card and then transmit payment breakdown information on the made payment to the terminal 100. The terminal 100 can display schematic information of the made payment on a payment breakdown window 510. For example, on a prescribed region of the display unit 151, the controller 180 can display that 25 dollars are paid using a quick pay through a default payment card. The terminal 100 can recognize that a screen mode of the terminal is switched to a second mode from a first mode. For example, the terminal 100 can recognize that it is switched to a landscape mode from a portrait mode. If switching to the landscape mode from the portrait mode, the controller 180 of the terminal 100 can display detailed information on the payment breakdown, e.g., a receipt 520 on the display unit 151 in the landscape mode. The controller 180 can display a save button 551 for saving information corresponding to the receipt 520 and a delete button 552 for deleting the information corresponding to the receipt 520 on the display unit 151. Based on an input to the save button 551 or the delete button 552, the terminal 100 can save or delete the information corresponding to the receipt 520. Thus, based on the card information of the default payment card, the terminal 100 enables the POS 200 to make payment by transmitting the card information to the POS 200. If switching to the landscape mode from the portrait mode, the terminal 100 can display a receipt for the paid breakdown. Thus, a user of the terminal enables the terminal 100 to output additional information related to the payment through the screen mode switching of the terminal.

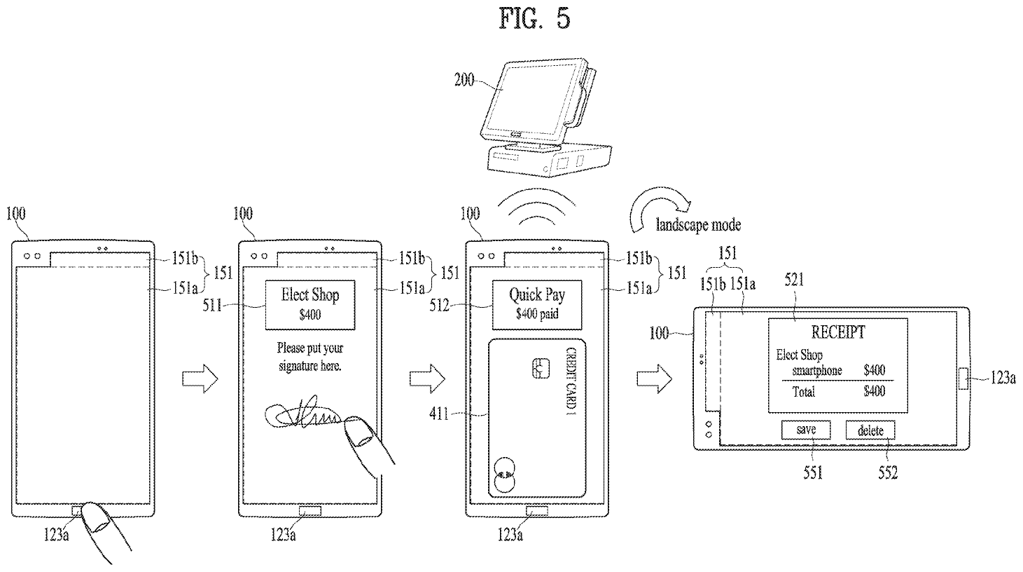

In some implementations, the terminal 100 can receive an input of a user's signature. If a user's signature is inputted, the terminal 100 may transmit card information for a payment. For example, if a payment amount is equal to or greater than a predetermined amount, the terminal 100 can transmit card information after receiving an input of a user's signature. If a payment amount is smaller than the predetermined amount, the terminal 100 may skip the step of receiving an input of a user's signature. This is described with reference to FIG. 5.

FIG. 5 is an exemplary diagram of a payment and receipt display operation over a predetermined amount according to various embodiments of the present invention.

Referring to FIG. 5, the controller 180 of the terminal 100 can recognize a user's fingerprint through the manipulating unit 123a in a first mode, e.g., a portrait mode. If recognizing the user's fingerprint, the controller 180 can execute a payment function and display a card image 411 of a default payment card, e.g., a first credit card on the display unit 151. If an amount to pay is equal to or greater than a predetermined amount, the controller 180 can display a signature input screen on the display unit 151. For example, if a payment amount exceeds 300 dollars, the controller 180 displays a signature input screen and also displays an information window 511 for a payment target shop and a payment amount. If a user's signature is inputted, the controller 180 can transmit card information of the first credit card corresponding to the default payment card to a Point Of Sale (POS) 200. For example, through the wireless communication unit 110, the controller 180 can transmit the card information of the first credit card to the POS 200 using at least one of an NFC signal and an MST signal. The POS 200 can make payment based on the transmitted card information of the first credit card and then transmit payment breakdown information on the made payment to the terminal 100. The terminal 100 can display schematic information of the made payment on a payment breakdown window 512. For example, on a prescribed region of the display unit 151, the controller 180 can display that 400 dollars are paid using a quick pay through a default payment card. The terminal 100 can recognize that a screen mode of the terminal is switched to a second mode from a first mode. For example, the terminal 100 can recognize that it is switched to a landscape mode from a portrait mode. If switching to the landscape mode from the portrait mode, the controller 180 of the terminal 100 can display detailed information on the payment breakdown, e.g., a receipt 520 on the display unit 151 in the landscape mode. The controller 180 can display a save button 551 for saving information corresponding to the receipt 520 and a delete button 552 for deleting the information corresponding to the receipt 520 on the display unit 151. Based on an input to the save button 551 or the delete button 552, the terminal 100 can save or delete the information corresponding to the receipt 520. Thus, based on the card information of the default payment card, the terminal 100 enables the POS 200 to make payment by transmitting the card information to the POS 200. If switching to the landscape mode from the portrait mode, the terminal 100 can display a receipt for the paid breakdown. Thus, a user of the terminal enables the terminal 100 to output additional information related to the payment through the screen mode switching of the terminal.

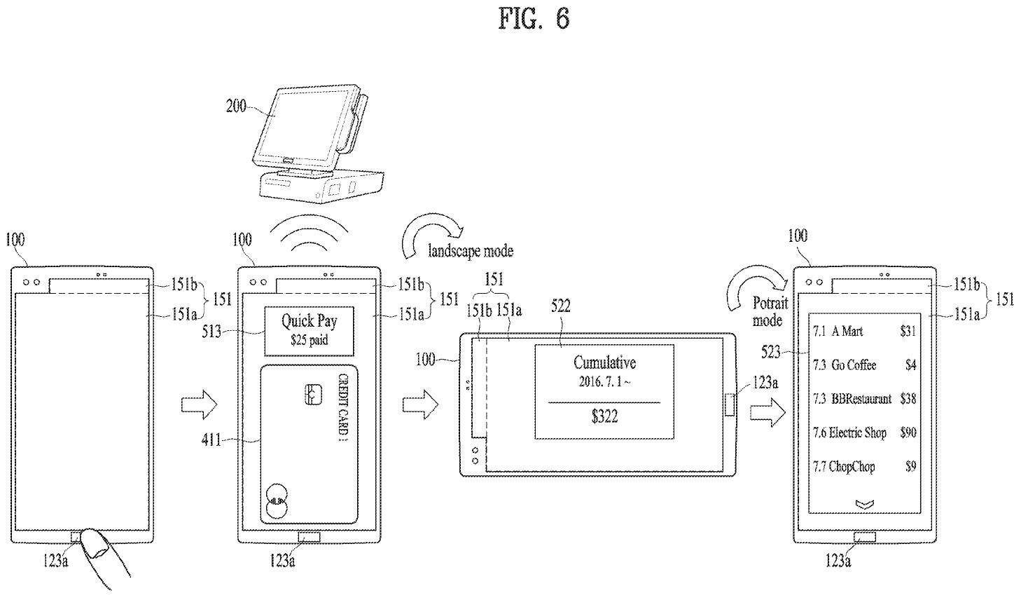

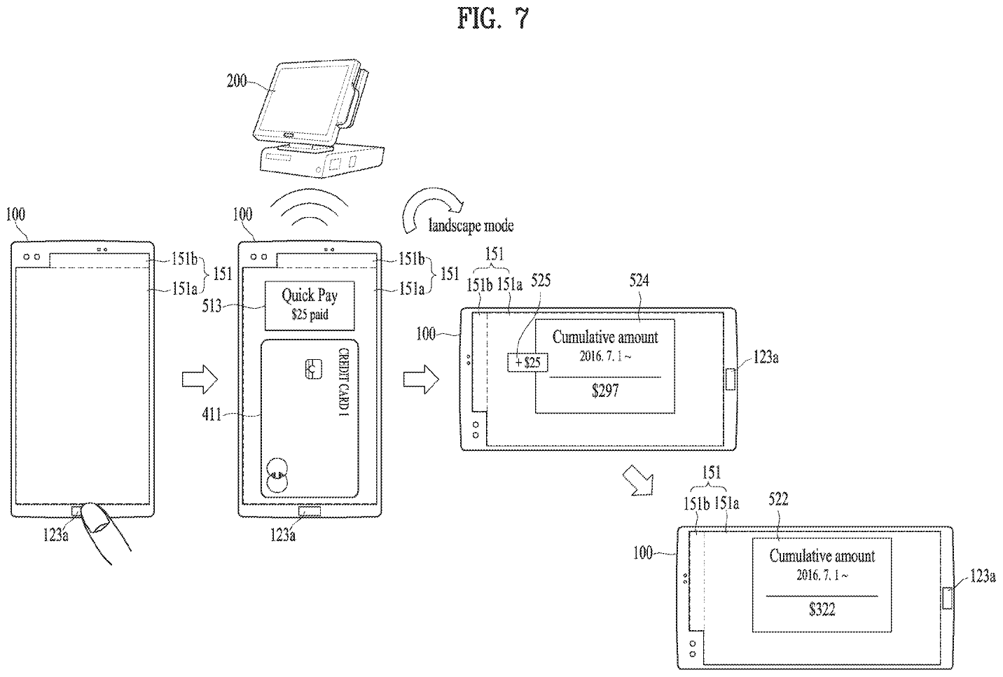

If recognizing a mode switching, the terminal 100 according to various embodiments can further display detailed information related to a payment. This is described with reference to FIG. 6 and FIG. 7.

FIG. 6 is an exemplary diagram for a cumulative amount display according to various embodiments of the present invention.

Referring to FIG. 6, the controller 180 of the terminal 100 can recognize a user's fingerprint through the manipulating unit 123a in a first mode, e.g., a portrait mode. If recognizing the user's fingerprint, the controller 180 can execute a payment function and display a card image 411 of a default payment card, e.g., a first credit card on the display unit 151. The controller 180 can transmit card information of the first credit card corresponding to the displayed first credit card image 411 to a Point Of Sale (POS) 200. For example, through the wireless communication unit 110, the controller 180 can transmit the card information of the first credit card to the POS 200 using at least one of an NFC signal and an MST signal. The POS 200 can make payment based on the transmitted card information of the first credit card and then transmit payment breakdown information on the made payment to the terminal 100. The terminal 100 can display schematic information of the made payment on a payment breakdown window 513. For example, on a prescribed region of the display unit 151, the controller 180 can display that 25 dollars are paid using a quick pay through the default payment card. The terminal 100 can recognize that a screen mode of the terminal is switched to a second mode from a first mode. For example, the terminal 100 can recognize that it is switched to a landscape mode from a portrait mode. If switching to the landscape mode from the portrait mode, the controller 180 of the terminal 100 can display a cumulative use amount of the first credit card used for the payment during a predetermined period on the display unit 151. For example, the controller 180 can display a cumulative use amount 522 of July on the display unit 151. If the terminal switches to the portrait mode from the landscape mode again, the controller 180 can display a use breakdown of the cumulative use amount of July on the display unit 151. Thus, a user of the terminal enables the terminal 100 to output additional information related to the payment through the screen mode switching of the terminal.

In some implementations, additional information displayed according to a mode switching of a terminal may be outputted based on various effects.

FIG. 7 is an exemplary diagram for a cumulative amount display effect according to various embodiments of the present invention.

Referring to FIG. 7, the controller 180 of the terminal 100 can recognize a user's fingerprint through the manipulating unit 123a in a first mode, e.g., a portrait mode. If recognizing the user's fingerprint, the controller 180 can execute a payment function and display a card image 411 of a default payment card, e.g., a first credit card on the display unit 151. The controller 180 can transmit card information of the first credit card corresponding to the displayed first credit card image 411 to a Point Of Sale (POS) 200. The terminal 100 can display schematic information of the made payment on a payment breakdown window 513. The terminal 100 can recognize that a screen mode of the terminal is switched to a second mode from a first mode. For example, the terminal 100 can recognize that it is switched to a landscape mode from a portrait mode. If switching to the landscape mode from the portrait mode, the controller 180 of the terminal 100 can display a cumulative use amount of the first credit card used for the payment during a predetermined period on the display unit 151. For example, the controller 180 can display an animation that an amount 525 paid previous to the mode switching is added to a cumulative use amount 524 of this month, i.e., July. And, the controller 180 can display a final cumulative amount 522 resulting from adding a currently paid amount 25 to the July cumulative use amount on the display unit 151. Thus, the terminal 100 can show the cumulative use amount of the card based on various effects.

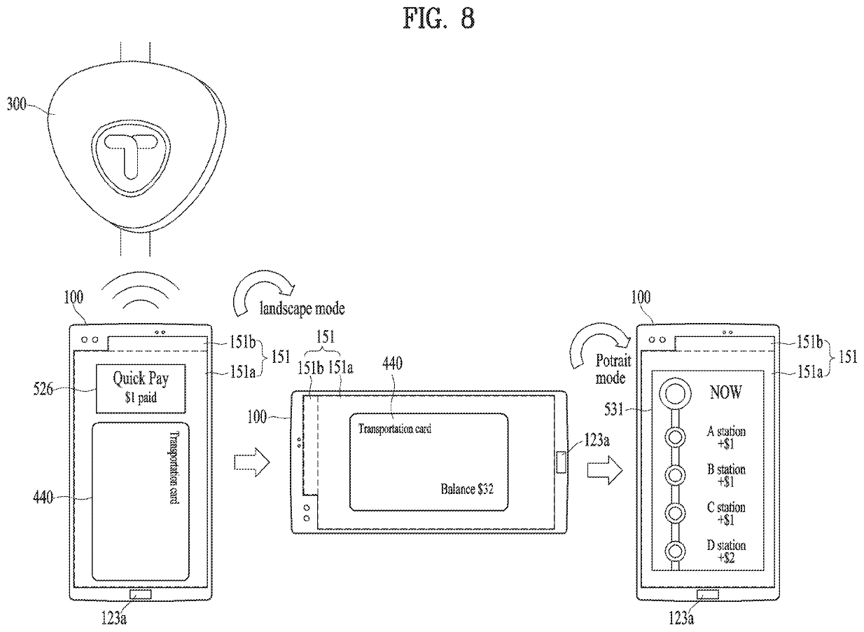

When a prepaid card such as a transportation card is used for payment, the terminal 100 according to various embodiments can output various kinds of information according to a mode switching. This is described with reference to FIG. 8.

FIG. 8 is an exemplary diagram for a transportation card payment according to various embodiments of the present invention.

Referring to FIG. 8, the controller 180 of the terminal 100 can recognize a user's fingerprint through the manipulating unit 123a in a first mode, e.g., a portrait mode. If recognizing the user's fingerprint, the controller 180 can execute a payment function. If another device corresponding to the payment function is a transportation terminal 300, the controller 180 can display a card image 440 of a transportation fee payment card, e.g., a transportation card on the display unit 151. For example, if receiving a payment information signal related to a transportation fee payment from a transportation terminal 300 tagged in a predetermined distance, the terminal 100 can execute a payment function and display a card image 440 of the transportation card on the display unit 151. The controller 180 can transmit card information corresponding to the displayed transportation card image 440 to the transportation terminal 300. For example, through the wireless communication unit 110, the controller 180 can transmit the card information of the transportation card to the transportation terminal 300 using at least one of an NFC signal and an MST signal. The transportation terminal 300 can make payment based on the transmitted card information of the transportation card and then transmit payment breakdown information on the made payment to the terminal 100. The terminal 100 can display schematic information of the made payment on a payment breakdown window 526. For example, on a prescribed region of the display unit 151, the controller 180 can display that 1 dollar is paid using a quick pay through the transportation card. The terminal 100 can recognize that a screen mode of the terminal is switched to a second mode from a first mode. For example, the terminal 100 can recognize that it is switched to a landscape mode from a portrait mode. If switching to the landscape mode from the portrait mode, the controller 180 of the terminal 100 can display detailed information of the transportation card, e.g., a charged balance of the transportation card on the transportation card image 440. If switching to the portrait mode from the landscape mode again, the terminal 100 can display information on travel sections of a currently on-board transportation means and additional charge amounts according to travels on the display unit 151. Thus, the terminal 100 can output additional information related to a payment according to a mode switching. If the mode switching is repeated, the terminal 100 can further output other additional payment information not displayed previously.

If it is advantageous that payment is made using a card other than a default payment card set for a quick pay, the terminal 100 according to various embodiments can display information on a card advantageous for payment and change a payment means into the card advantageous for the payment.

FIG. 9 is an exemplary diagram for a payment change according to various embodiments of the present invention.

Referring to FIG. 9, the controller 180 of the terminal 100 can recognize a user's fingerprint through the manipulating unit 123a in a first mode, e.g., a portrait mode. If recognizing the user's fingerprint, the controller 180 can execute a payment function and display a card image 411 of a default payment card, e.g., a first credit card on the display unit 151. The controller 180 can transmit card information of the first credit card corresponding to the displayed first credit card image 411 to a Point Of Sale (POS) 200. For example, through the wireless communication unit 110, the controller 180 can transmit the card information of the first credit card to the POS 200 using at least one of an NFC signal and an MST signal. The POS 200 can make payment based on the transmitted card information of the first credit card and then transmit payment breakdown information on the made payment to the terminal 100. The terminal 100 can display schematic information of the made payment on a payment breakdown window 513. For example, on a prescribed region of the display unit 151, the controller 180 can display that 25 dollars are paid using a quick pay through the default payment card. Moreover, the controller 180 can output a discountable card and discount information to a sub-display region 151b. For example, the controller 180 can display an indicator 463 for a discountable third credit card and an available discount rate ‘5%’ on the sub-display region 151b. The terminal 100 can recognize that a screen mode of the terminal is switched to a second mode from a first mode. For example, the terminal 100 can recognize that it is switched to a landscape mode from a portrait mode. If switching to the landscape mode from the portrait mode, the controller 180 of the terminal 100 can output a payment breakdown estimated in case of making payment through the third credit card. For example, the controller 180 can display a payment breakdown, which is estimated in case of making payment through the third credit card, on the card image. As one embodiment, the controller 180 can display 25 dollars, which will be cancelled, on the first credit card image 411 and also display 23.5 dollars, which will be paid, on a third credit card image 413. If switching to the portrait mode from the landscape mode again, the terminal 100 can cancel the payment breakdown paid with the first credit card, which is the default payment card, and then make payment with the third credit card again. For example, the controller 180 can make requests, to the POS 200, for cancelling the payment breakdown paid with the first credit card and making payment again with the card information of the third credit card again. Then, the terminal 100 can receive information on the requested payment cancellation for the first credit card and the breakdown paid again with the third credit card. The controller 180 can display the third card image 413 and also display schematic information on the paid-again breakdown information on the payment breakdown window 527. Thus, the terminal 100 can output card information on a card advantageous for payment and make payment again with the card advantageous for the payment. In some implementations, the above-described indicator may include a card image. An indicator described in the following may include a card image of a corresponding card.

In some implementations, the terminal 100 may make payment again using a recommended card based not on a mode switching but on a user input.

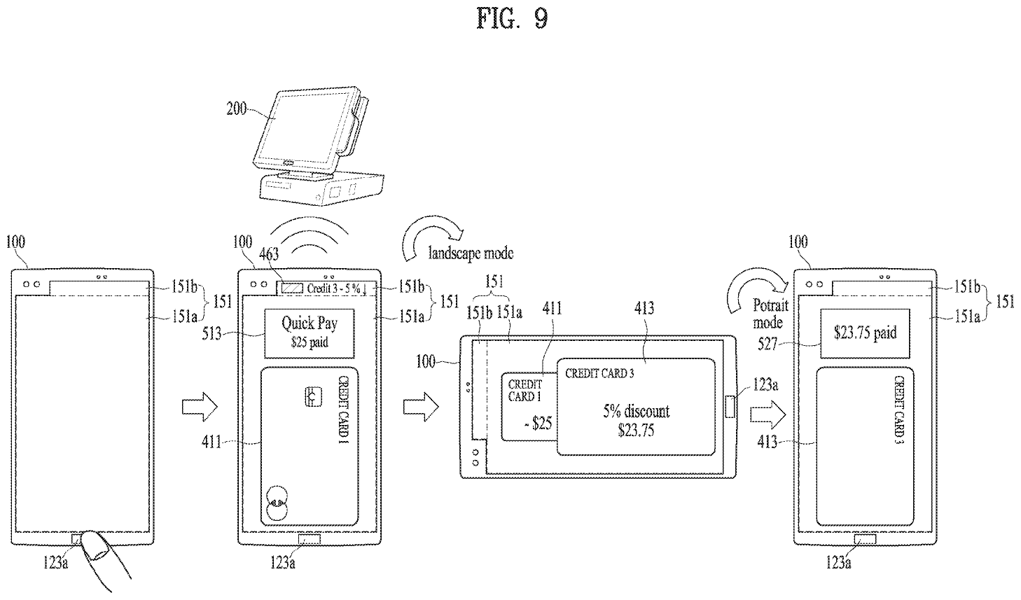

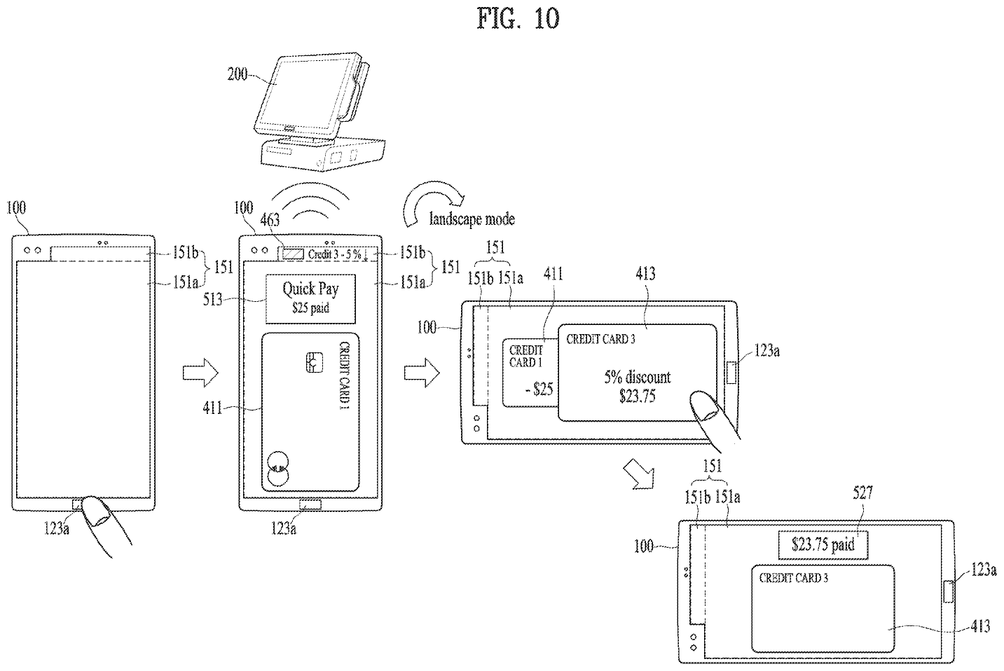

FIG. 10 is an exemplary diagram for a payment change according to various embodiments of the present invention.

Referring to FIG. 10, the controller 180 of the terminal 100 can recognize a user's fingerprint through the manipulating unit 123a in a first mode, e.g., a portrait mode. If recognizing the user's fingerprint, the controller 180 can execute a payment function and display a card image 411 of a default payment card, e.g., a first credit card on the display unit 151. The controller 180 can transmit card information of the first credit card corresponding to the displayed first credit card image 411 to a Point Of Sale (POS) 200. The POS 200 can make payment based on the transmitted card information of the first credit card and then transmit payment breakdown information on the made payment to the terminal 100. The terminal 100 can display schematic information of the made payment on a payment breakdown window 513. For example, on a prescribed region of the display unit 151, the controller 180 can display that 25 dollars are paid using a quick pay through the default payment card. Moreover, the controller 180 can output a discountable card and discount information to a sub-display region 151b. For example, the controller 180 can display an indicator 463 for a discountable third credit card and an available discount rate ‘5%’ on the sub-display region 151b. The terminal 100 can recognize that a screen mode of the terminal is switched to a second mode from a first mode. For example, the terminal 100 can recognize that it is switched to a landscape mode from a portrait mode. If switching to the landscape mode from the portrait mode, the controller 180 of the terminal 100 can output a payment breakdown estimated in case of making payment through the third credit card. For example, the controller 180 can display a payment breakdown, which is estimated in case of making payment through the third credit card, on the card image. As one embodiment, the controller 180 can display 25 dollars, which will be cancelled, on the first credit card image 411 and also display 23.5 dollars, which will be paid, on a third credit card image 413. If obtaining an input of tapping the recommended third credit card image 413, the terminal 100 can cancel the payment breakdown paid with the first credit card, which is the default payment card, and then make payment with the third credit card again. For example, the controller 180 can make requests, to the POS 200, for cancelling the payment breakdown paid with the first credit card and making payment again with the card information of the third credit card again. Then, the terminal 100 can receive information on the requested payment cancellation for the first credit card and the breakdown paid again with the third credit card. The controller 180 can display the third card image 413 and also display schematic information on the paid-again breakdown information on the payment breakdown window 527. Thus, the terminal 100 can output card information on a card advantageous for payment and make payment again with the card advantageous for the payment.

The terminal 100 according to various embodiments can output information on at least one of a mileage accumulation card and a discount card, which are usable for making payment, and make payment again according to the breakdown to which accumulation or discount is applied.

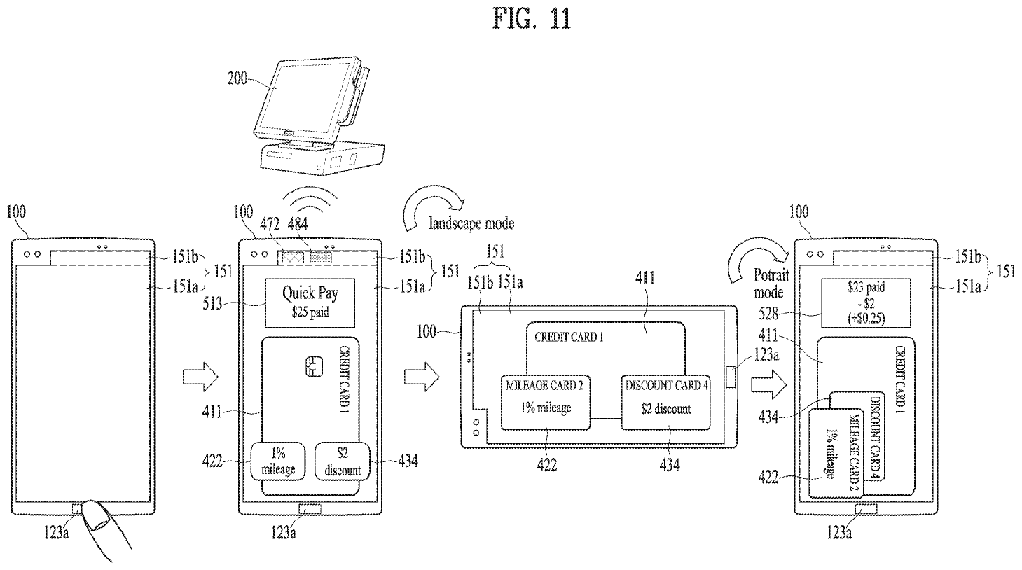

FIG. 11 is an exemplary diagram for a discount/accumulation applied payment according to various embodiments of the present invention.

Referring to FIG. 11, the controller 180 of the terminal 100 can recognize a user's fingerprint through the manipulating unit 123a in a first mode, e.g., a portrait mode. If recognizing the user's fingerprint, the controller 180 can execute a payment function and display a card image 411 of a default payment card, e.g., a first credit card on the display unit 151. The controller 180 can transmit card information of the first credit card corresponding to the displayed first credit card image 411 to a Point Of Sale (POS) 200. For example, through the wireless communication unit 110, the controller 180 can transmit the card information of the first credit card to the POS 200 using at least one of an NFC signal and an MST signal. The POS 200 can make payment based on the transmitted card information of the first credit card and then transmit payment breakdown information on the made payment to the terminal 100. The terminal 100 can display schematic information of the made payment on a payment breakdown window 513. For example, on a prescribed region of the main display unit 151a, the controller 180 can display that 25 dollars are paid using a quick pay through the default payment card. Moreover, to the sub-display region 151b, the controller 180 can output at least one of an accumulative card, a discountable card, accumulation information and discount information. For example, the controller 180 can display an indicator 472 for an accumulative second mileage card and an indicator 484 for a discountable fourth discount card on the sub-display region 151b. Moreover, on a prescribed region of the main display unit 151a, the controller 180 may display a second mileage card image 422 and a fourth discount card image 434. The controller 180 can display an accumulation rate on the displayed second mileage card image 422 and also display a discount amount on the displayed fourth discount card image 434. The terminal 100 can recognize that a screen mode of the terminal is switched to a second mode from a first mode. For example, the terminal 100 can recognize that it is switched from a portrait mode to a landscape mode. If switching to the landscape mode from the portrait mode, the controller 180 of the terminal 100 can be activated to transmit card information on each of the first credit card, the second mileage card and the fourth discount card. If switching to the portrait mode from the landscape mode again, the terminal 100 can apply the first credit card, the second mileage card and the fourth discount card to payment. For example, the controller 180 can request the POS 200 to cancel the payment breakdown paid with the first credit card and make payment again so as to apply the accumulation according to the second mileage card and the discount according to the fourth discount card thereto. And, from the POS 200, the terminal 100 can receive information on a new payment breakdown having the second mileage card and the fourth discount card applied thereto. The controller 180 can display the first card image 411, the fourth discount card image 434 and the second mileage card image 422 and also display schematic information on the paid-again payment breakdown on the payment breakdown window 528. Thus, the terminal 100 can output card information on a discountable/accumulative card and enable discount/accumulation to be applied to payment.

In some implementations, the terminal 100 may make payment to which discount/accumulation is applied through a process simpler than the above-described process.

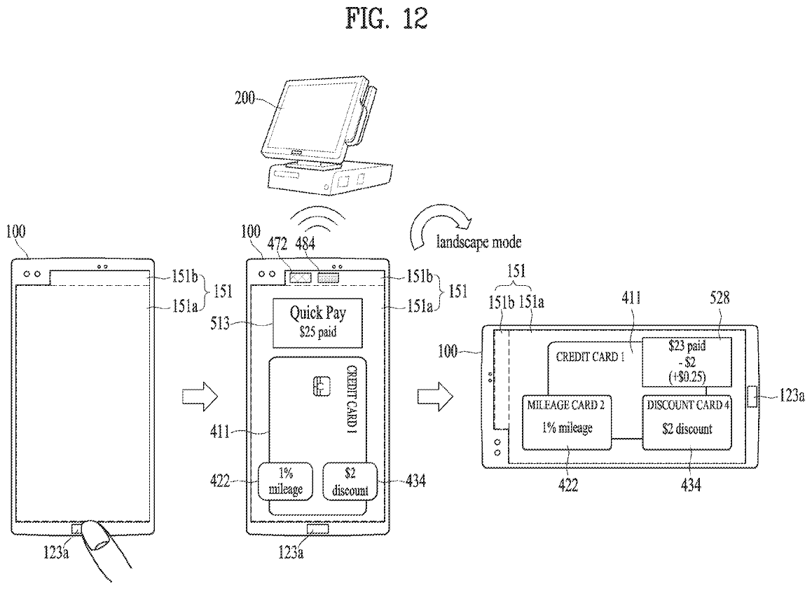

FIG. 12 is an exemplary diagram for a discount/accumulation applied payment according to various embodiments of the present invention.

Referring to FIG. 12, the controller 180 of the terminal 100 can recognize a user's fingerprint through the manipulating unit 123a in a first mode, e.g., a portrait mode. If recognizing the user's fingerprint, the controller 180 can execute a payment function and display a card image 411 of a default payment card, e.g., a first credit card on the display unit 151. The controller 180 can transmit card information of the first credit card corresponding to the displayed first credit card image 411 to a Point Of Sale (POS) 200. For example, through the wireless communication unit 110, the controller 180 can transmit the card information of the first credit card to the POS 200 using at least one of an NFC signal and an MST signal. The POS 200 can make payment based on the transmitted card information of the first credit card and then transmit payment breakdown information on the made payment to the terminal 100. The terminal 100 can display schematic information of the made payment on a payment breakdown window 513. For example, on a prescribed region of the main display unit 151a, the controller 180 can display that 25 dollars are paid using a quick pay through the default payment card. Moreover, to the sub-display region 151b, the controller 180 can output at least one of an accumulative card, a discountable card, accumulation information and discount information. For example, the controller 180 can display an indicator 472 for an accumulative second mileage card and an indicator 484 for a discountable fourth discount card on the sub-display region 151b. Moreover, on a prescribed region of the main display unit 151a, the controller 180 may display a second mileage card image 422 and a fourth discount card image 434. The controller 180 can display an accumulation rate on the displayed second mileage card image 422 and also display a discount amount on the displayed fourth discount card image 434. The terminal 100 can recognize that a screen mode of the terminal is switched to a second mode from a first mode. For example, the terminal 100 can recognize that it is switched from a portrait mode to a landscape mode. If switching to the landscape mode from the portrait mode, the controller 180 of the terminal 100 can apply the first credit card, the second mileage card and the fourth discount card to payment. For example, the controller 180 can request the POS 200 to cancel the payment breakdown paid with the first credit card and make payment again so as to apply the accumulation according to the second mileage card and the discount according to the fourth discount card thereto. And, from the POS 200, the terminal 100 can receive information on a new payment breakdown having the second mileage card and the fourth discount card applied thereto. The controller 180 can display the first card image 411, the fourth discount card image 434 and the second mileage card image 422 and also display schematic information on the paid-again payment breakdown on the payment breakdown window 528. Thus, the terminal 100 may make discount/accumulation applied payment based on a single mode switching.

The terminal 100 according to various embodiments can upload payment breakdown to SNS in response to a mode switching.

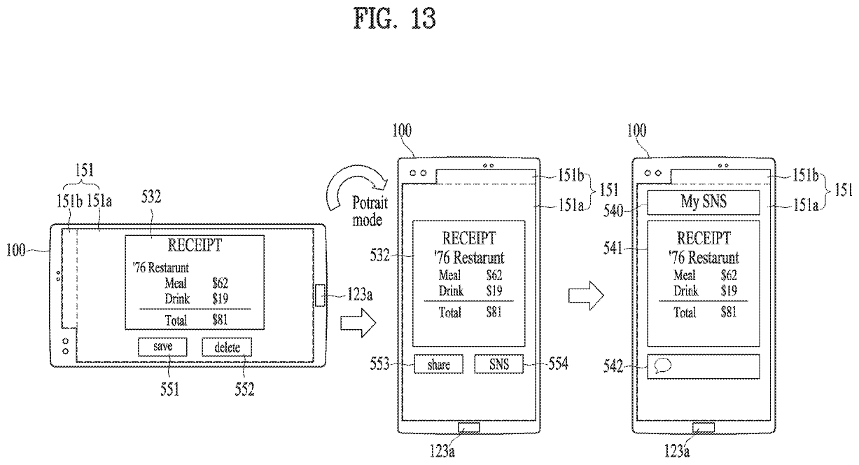

FIG. 13 is an exemplary diagram for an SNS upload of a payment breakdown according to various embodiments of the present invention.

Referring to FIG. 13, the controller 180 of the terminal 100 can display a receipt 532 for the made payment on the display unit 151 and also display a save button 551 for saving information corresponding to the receipt 532 and a delete button 552 for deleting the information corresponding to the receipt 532 on the display unit 151. If switching to a portrait mode from a landscape mode, the terminal can display a share button 553 for sharing the displayed receipt 532 and an SNS button 554 for uploading the displayed receipt 532 to SNS on the display unit 151. If obtaining an input of tapping the SNS button 554, the terminal 100 may upload an image 541 of the displayed receipt to the SNS 540 and display an input window 542 for inputting a text for the uploaded image 541. Moreover, the terminal 100 can mosaic personal information (e.g., a card number, a card expiration date, etc.) included in the receipt 532 and upload a mosaicked image to the SNS. Thus, the terminal 100 can upload payment breakdown to SNS in response to a mode switching.

The terminal 100 according to various embodiments may share payment breakdown and request a settlement amount.

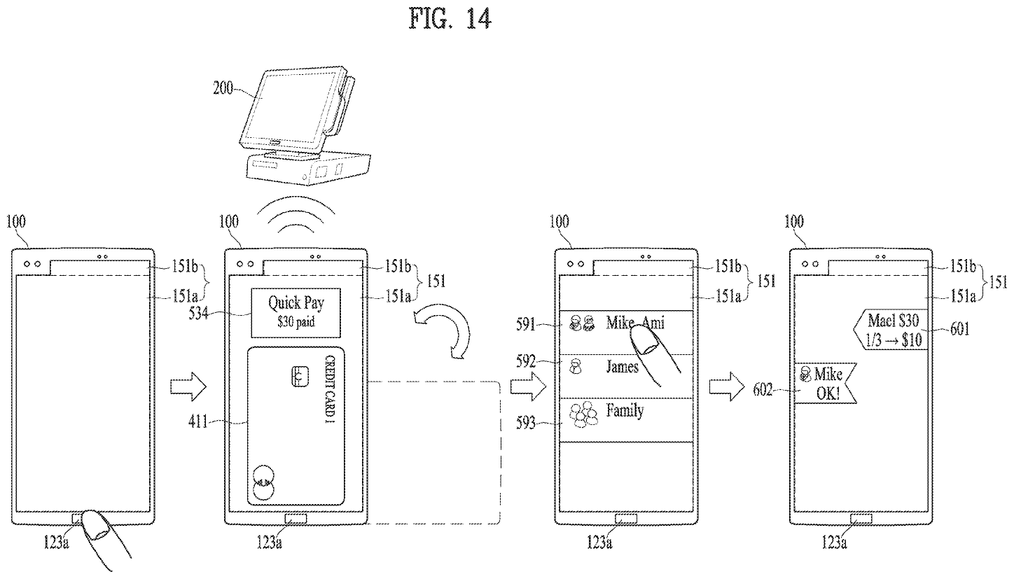

FIG. 14 is an exemplary diagram for a payment breakdown sharing and an amount settlement message transmission according to various embodiments of the present invention.

Referring to FIG. 14, the controller 180 of the terminal 100 can recognize a user's fingerprint through the manipulating unit 123a in a first mode, e.g., a portrait mode. If recognizing the user's fingerprint, the controller 180 can execute a payment function and display a card image 411 of a default payment card, e.g., a first credit card on the display unit 151. The controller 180 can transmit card information of the first credit card corresponding to the displayed first credit card image 411 to a Point Of Sale (POS) 200. For example, through the wireless communication unit 110, the controller 180 can transmit the card information of the first credit card to the POS 200 using at least one of an NFC signal and an MST signal. The POS 200 can make payment based on the transmitted card information of the first credit card and then transmit payment breakdown information on the made payment to the terminal 100. The terminal 100 can display schematic information of the made payment on a payment breakdown window 534. For example, on a prescribed region of the display unit 151, the controller 180 can display that 30 dollars are paid using a quick pay through the default payment card. The terminal 100 can recognize that a screen mode of the terminal is switched to a second mode from a first mode. For example, the terminal 100 can recognize that it is switched to a landscape mode from a portrait mode and then switched back to the portrait mode from the landscape mode. If switching to the landscape mode from the portrait mode and then switching back to the portrait mode from the landscape mode within a predetermined time, the controller 180 of the terminal 100 can share payment breakdown through a messenger application. For example, if switching to the landscape mode from the portrait mode and then switching back to the portrait mode from the landscape mode within a predetermined time, the controller 180 can display a plurality of chat windows 591 to 593. Here, a plurality of the displayed chat windows 591 to 593 may include chat windows activated in the messenger application. The controller 180 can obtain an input of selecting one of the displayed chat windows 591 to 593. For example, the controller 180 can obtain an input of selecting the first chat window 591 as a chat window for sharing the payment breakdown. The controller 180 can share the payment breakdown on the selected chat window and transmit a message for a settlement amount. For example, if 3 persons settle the paid 30 dollars, the controller 180 can send a settlement amount message 601, which indicates that each person should pay 10 dollars, to users included in the first chat window 591. Thus, the terminal 100 can share payment breakdown and send a message about a settlement amount, in response to a mode switching.

In some implementations, if receiving a message about a settlement amount, the terminal 100 can pay or remit the settlement amount based on the received message.

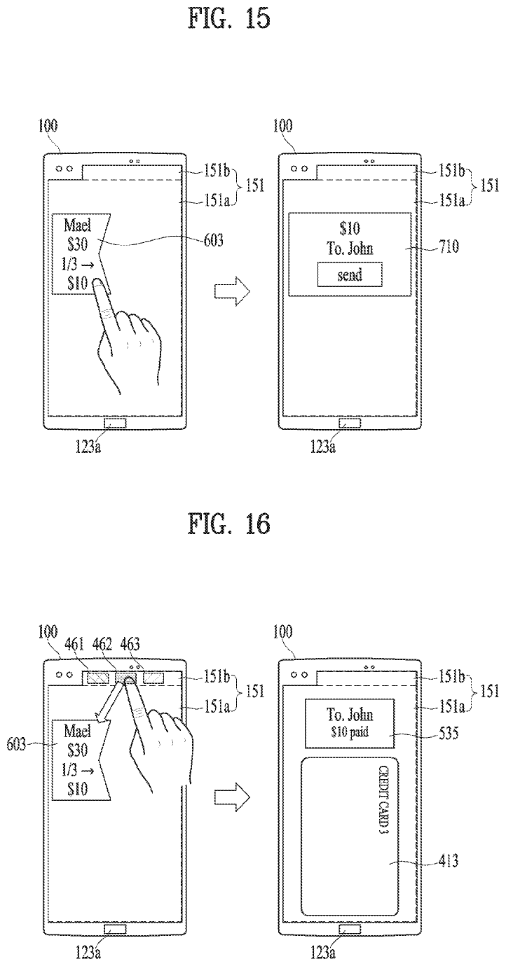

FIG. 15 is an exemplary diagram for a settlement amount transfer according to various embodiments of the present invention.

Referring to FIG. 15, the terminal 100 can receive a message 603 about a settlement amount. The controller 180 can display the received message 603 about the settlement amount on the display unit 151. If obtaining an input of tapping the displayed message 603, the controller 180 can pay the settlement amount. For example, the controller 180 can remit the requested settlement amount ‘10 dollars’ to a settlement requesting user, John.

FIG. 16 is an exemplary diagram for a settlement amount payment according to various embodiments of the present invention.

Referring to FIG. 16, the terminal 100 can receive a message 603 about a settlement amount. The controller 180 can display the received message 603 about the settlement amount on the main display unit 151a and also display an indicator about a payable card on the sub-display unit 151b. For example, the controller 180 can display indicators 461 to 463 respectively corresponding to first to third cards corresponding to the payable cards on the sub-display unit 151b. The controller 180 can obtain an input of dragging & dropping one 462 of a plurality of the indicators 461 to 463 displayed on the sub-display unit 151b to the message 603. The controller 180 can pay the requested settlement amount ‘30 dollars’ with the third credit card corresponding to the dragged & dropped indicator 462. The controller 180 can display a card image 413 of the third credit card corresponding to the dragged & dropped indicator 462 and also display information on the paid breakdown on a payment window 535.

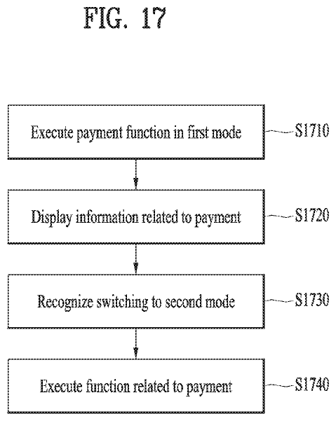

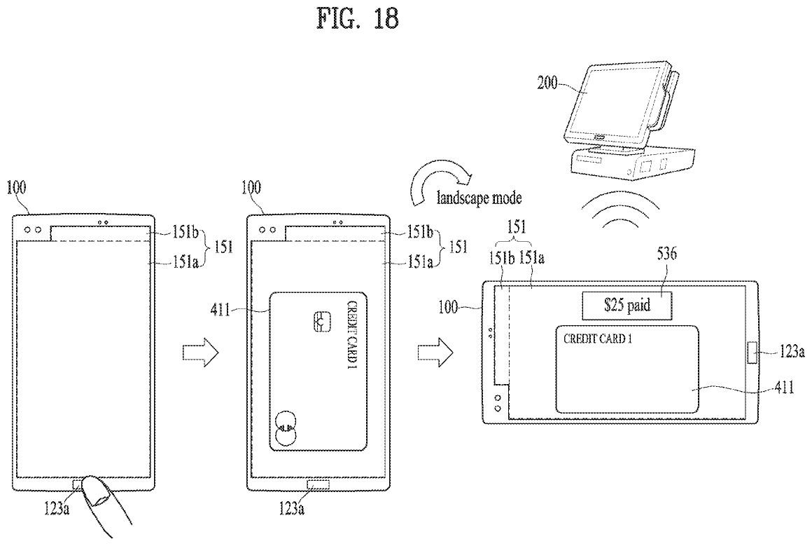

The terminal 100 according to various embodiments may make payment in case of a mode switching. This is described with reference to FIG. 17 and FIG. 18.

FIG. 17 is a flowchart for a payment operation according to various embodiments of the present invention.

Referring to FIG. 17, the terminal 100 can execute a payment function in first mode [S1710].

The controller 180 of the terminal can execute a payment function capable of transmitting a payment signal in the first mode. For example, the controller 180 can launch a payment application. Here, the first mode may include a screen mode of the terminal 100, e.g., a portrait mode or a landscape mode. For example, the first mode may mean the portrait mode of the terminal 100. Moreover, the first mode may include the landscape mode of the terminal 100.

The terminal 100 can display information related to payment [S1720].

For example, the controller 180 can display information on at least one payment means that is to be applied to payment. As one embodiment, the controller 180 can display a card image of a default payment card, which is to be applied to payment, on the display unit 151.

The terminal 100 can recognize a switching to a second mode [S1730].

Based on a sensing value of the sensing unit 140, the controller 180 of the terminal 100 can recognize that a screen mode of the terminal is switched to the second mode from the first mode.

If recognizing the mode switching, the terminal 100 can make payment [ S1740].

For example, through the wireless communication unit 110, the controller 180 can transmit the information on the payment means, which is displayed as information related to the payment, to another device that will make payment. Hence, the controller 180 enables another device to make payment based on the transmitted information on the payment means.

As one embodiment, through the wireless communication unit 110, the controller 180 can transmit the card information of the default payment card to another device that will make payment.

A detailed embodiment for the above-described payment operation is described with reference to FIG. 18.

FIG. 18 is an exemplary diagram for a payment operation according to various embodiments of the present invention.

Referring to FIG. 18, the controller 180 of the terminal 100 can recognize a user's fingerprint through the manipulating unit 123a in a first mode, e.g., a portrait mode. If recognizing the user's fingerprint, the controller 180 can execute a payment function and display a card image 411 of a default payment card, e.g., a first credit card on the display unit 151. The terminal 100 can recognize that a screen mode of the terminal is switched to a second mode from a first mode. For example, the terminal 100 can recognize that it is switched to a landscape mode from a portrait mode. If switching to the landscape mode from the portrait mode, the controller 180 can transmit card information of the first credit card corresponding to the displayed first credit card image 411 to a Point Of Sale (POS) 200. For example, through the wireless communication unit 110, the controller 180 can transmit the card information of the first credit card to the POS 200 using at least one of an NFC signal and an MST signal. The POS 200 can make payment based on the transmitted card information of the first credit card and then transmit payment breakdown information on the made payment to the terminal 100. The terminal 100 can display schematic information of the made payment on a payment breakdown window 536. For example, on a prescribed region of the display unit 151, the controller 180 can display that 25 dollars are paid using a quick pay through a default payment card. Thus, the terminal 100 may make payment in response to a mode switching of the terminal.

The terminal 100 according to various embodiments can perform a function related to payment using various payment informations displayed on a plurality of display regions, e.g., a main display region and a sub-display region.

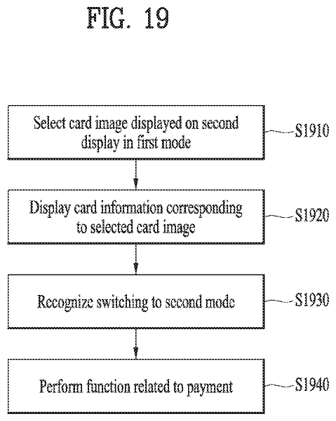

FIG. 19 is a flowchart for a payment function executing operation according to various embodiments of the present invention.

Referring to FIG. 19, the terminal 100 can obtain an input of selecting a card image displayed on the sub-display region 151b in first mode [81910].

For example, the terminal 100 can obtain an input of selecting a card image from a plurality of card images displayed on the sub-display region 151b in landscape mode. Here, the card image may include an indicator corresponding to the aforementioned card.

The terminal 100 can display card information corresponding to the selected card image [81920].

For example, the controller 180 can display the card information corresponding to the selected card image on the main display region 151a. As one embodiment, the controller 180 can display the card information corresponding to the selected card image, e.g., a detailed card image on the main display region 151a.

The terminal 100 can recognize a switching to a second mode [81930].

Based on a sensing value of the sensing unit 140, the controller 180 of the terminal 100 can recognize that a screen mode of the terminal is switched to the second mode from the first mode.

For example, based on the sensing value of the sensing unit 140, the controller 180 can recognize that it is switched to the portrait mode from the landscape mode.

The terminal 100 can perform a function related to payment [81940].

For example, the terminal 100 can transmit the card information displayed on the main display region 151a to another device. Hence, another device can make payment based on the transmitted card information.

For another example, the terminal 100 can display additional information related to the card information displayed on the main display region 151a.

For further example, using the card information displayed on the main display region 151a, the terminal 100 can perform an additional function related to the payment.

As further embodiment, if recognizing the mode switching, the controller 180 can additionally perform an additional payment related to the payment, e.g., mileage accumulation, discount, etc.

As another further embodiment, the controller 180 can perform additional settings related to the payment.

A detailed embodiment for the above-described operation is described as follows.

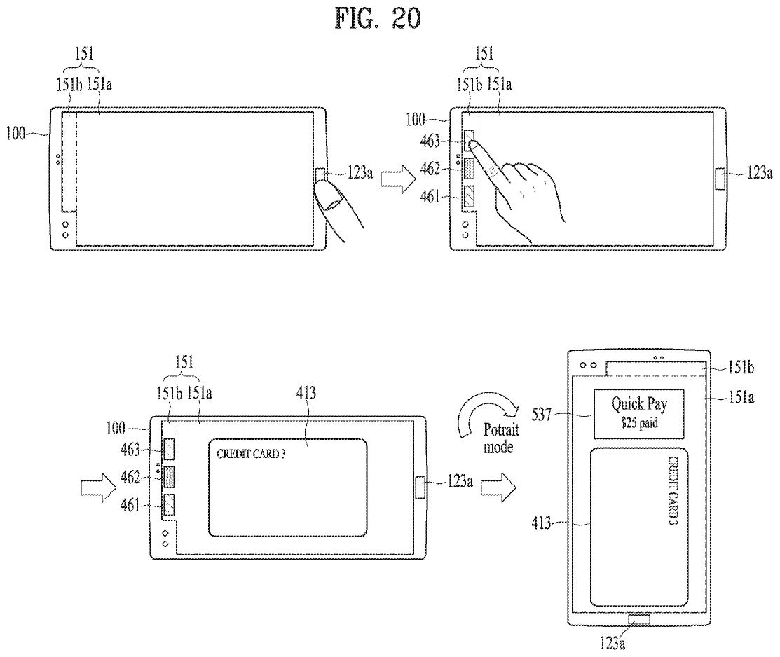

FIG. 20 is an exemplary diagram for a payment operation according to various embodiments of the present invention.

Referring to FIG. 20, the controller 180 of the terminal 100 can recognize a user's fingerprint through the manipulating unit 123a in first mode, e.g., landscape mode. If recognizing the user's fingerprint, the controller 180 can execute a payment function and display a plurality of indicators 461 to 463 on the sub-display region 151b. If obtaining an input of selecting one of a plurality of the indicators 461 to 463 displayed on the sub-display region 151b, the controller 180 can display a third credit card image 413 corresponding to the selected indicator 463 on the main display unit 151a. Based on a sensing value of the sensing unit 140, the controller 180 of the terminal 100 can recognize that a screen mode of the terminal is switched to a second mode from the first mode. For example, based on a sensing value of the sensing unit 140, the controller 180 can recognize that it is switched to the portrait mode from the landscape mode. If switching to the second mode from the first mode, the controller 180 can transmit card information of a third credit card corresponding to the displayed third credit card image 413 to another device to make payment, e.g., the POS 200. Hence, another device, e.g., the POS 200 can make payment based on the transmitted card information. The terminal 100 can display schematic information on the made payment on a payment breakdown window 537. For example, on a prescribed region of the display unit 151, the controller 180 can display that 25 dollars are paid through a quick pay using the third credit card. Thus, the terminal 100 can display an indicator indicating a card on the sub-display region 151b and also display a card image for a selected indicator on the main display 151a. And, in response to a mode switching, the terminal 100 can make payment based on card information corresponding to the displayed card image.

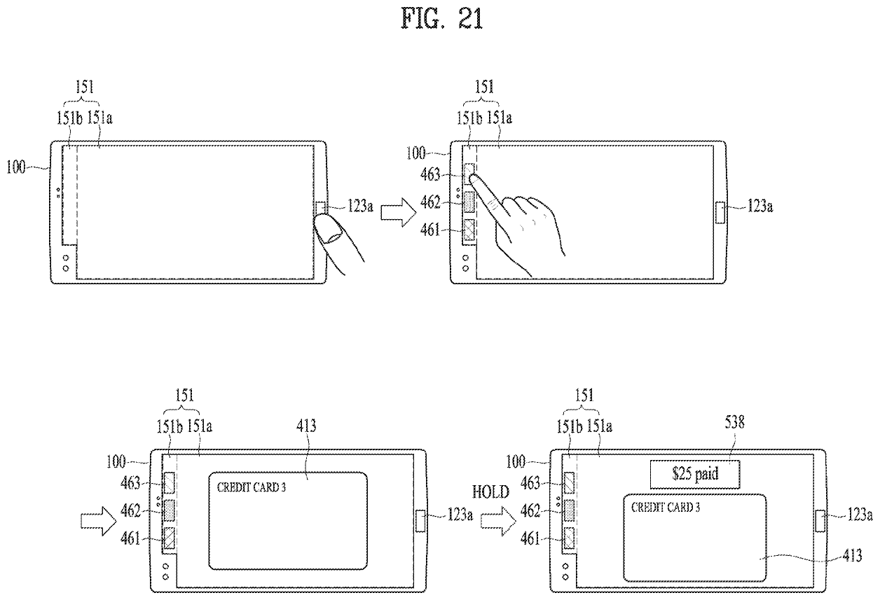

FIG. 21 is an exemplary diagram for a payment operation according to various embodiments of the present invention.

Referring to FIG. 21, the controller 180 of the terminal 100 can recognize a user's fingerprint through the manipulating unit 123a in first mode, e.g., landscape mode. If recognizing the user's fingerprint, the controller 180 can execute a payment function and display a plurality of indicators 461 to 463 on the sub-display region 151b. If obtaining an input of selecting one of a plurality of the indicators 461 to 463 displayed on the sub-display region 151b, the controller 180 can display a third credit card image 413 corresponding to the selected indicator 463 on the main display unit 151a. Based on a sensing value of the sensing unit 140, the controller 180 of the terminal 100 can recognize that the terminal 100 is held for a predetermined time. For example, the controller 180 of the terminal 100 can recognize a hold state that the terminal 100 is held for a predetermined time. If recognizing the hold state, the controller 180 can transmit card information of a third credit card corresponding to the displayed third credit card image 413 to another device to make payment, e.g., the POS 200. Hence, another device, e.g., the POS 200 can make payment based on the transmitted card information. The terminal 100 can display schematic information on the made payment on a payment breakdown window 538. For example, on a prescribed region of the display unit 151, the controller 180 can display that 25 dollars are paid through a quick pay using the third credit card. Thus, the terminal 100 can display an indicator indicating a card on the sub-display region 151b and also display a card image for a selected indicator on the main display 151a. And, if recognizing the hold state of the terminal, the terminal 100 can make payment based on card information corresponding to the displayed card image.

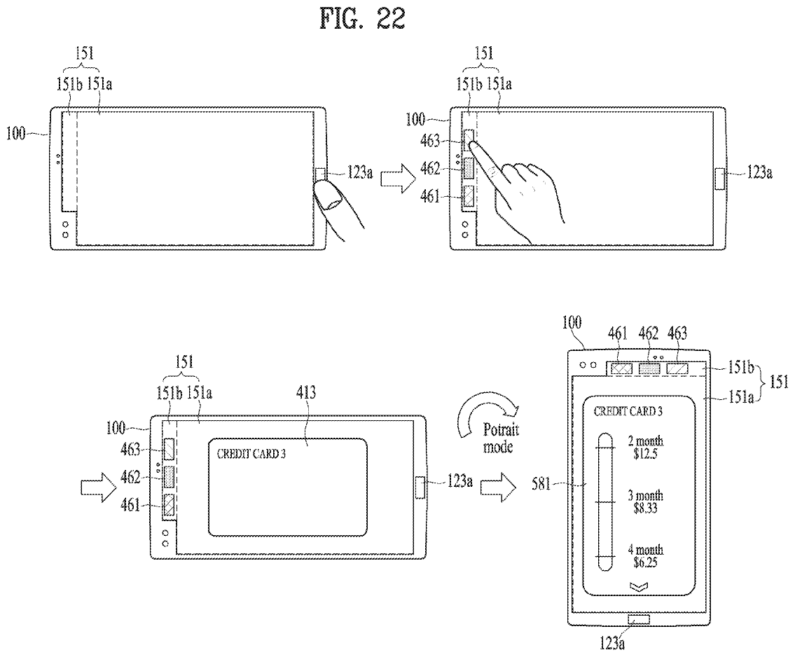

FIG. 22 is an exemplary diagram for an installment period setting according to various embodiments of the present invention.

Referring to FIG. 22, the controller 180 of the terminal 100 can recognize a user's fingerprint through the manipulating unit 123a in first mode, e.g., landscape mode. If recognizing the user's fingerprint, the controller 180 can execute a payment function and display a plurality of indicators 461 to 463 on the sub-display region 151b. If obtaining an input of selecting one of a plurality of the indicators 461 to 463 displayed on the sub-display region 151b, the controller 180 can display a third credit card image 413 corresponding to the selected indicator 463 on the main display unit 151a. Based on a sensing value of the sensing unit 140, the controller 180 of the terminal 100 can recognize that a screen mode of the terminal is switched to a second mode from the first mode. For example, based on a sensing value of the sensing unit 140, the controller 180 can recognize that it is switched to the portrait mode from the landscape mode. If switching to the second mode from the first mode, the controller 180 can display an installment period setting window 581 for setting an installment period of a payment using card information of a third credit card corresponding to the displayed third credit card image 413 on the main display region 151a. If obtaining an input of selecting an installment period displayed on the installment period setting window 581, the controller 180 can make payment to which the selected installment period is applied. For example, if an installment period of 2 months is selected, the controller 180 can transmit card information of the third credit card and information on the 2-month installment period to another device to make payment, e.g., the POS 200. Hence, another device, e.g., the POS 200 can make payment based on the transmitted card information and installment period. Thus, the terminal 100 can display an indicator indicating a card on the sub-display region 151b and also display a card image for a selected indicator on the main display 151a. And, in response to a mode switching, the terminal 100 can set details (e.g., installment period) for payment using card information corresponding to the displayed card image.

FIG. 23 is an exemplary diagram for a recent payment breakdown according to various embodiments of the present invention.

Referring to FIG. 23, the controller 180 of the terminal 100 can recognize a user's fingerprint through the manipulating unit 123a in first mode, e.g., landscape mode. If recognizing the user's fingerprint, the controller 180 can execute a payment function and display a plurality of indicators 461 to 463 on the sub-display region 151b. If obtaining an input of selecting one of a plurality of the indicators 461 to 463 displayed on the sub-display region 151b, the controller 180 can display a third credit card image 413 corresponding to the selected indicator 463 on the main display unit 151a. Based on a sensing value of the sensing unit 140, the controller 180 of the terminal 100 can recognize that a screen mode of the terminal is switched to a second mode from the first mode. For example, based on a sensing value of the sensing unit 140, the controller 180 can recognize that it is switched to the portrait mode from the landscape mode. If switching to the second mode from the first mode, the controller 180 can display a recent payment breakdown 582 of a third credit card corresponding to the displayed third credit card image 413 on the main display region 151a. Thus, the terminal 100 can display an indicator indicating a card on the sub-display region 151b and also display a card image for a selected indicator on the main display 151a. And, in response to a mode switching, the terminal 100 can display a payment breakdown (e.g., recent payment breakdown) using card information corresponding to the displayed card image.

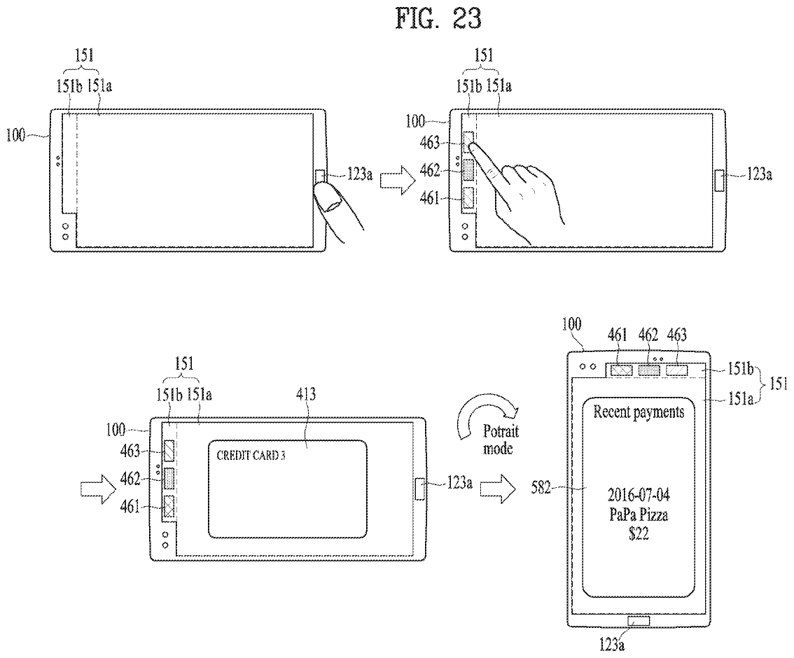

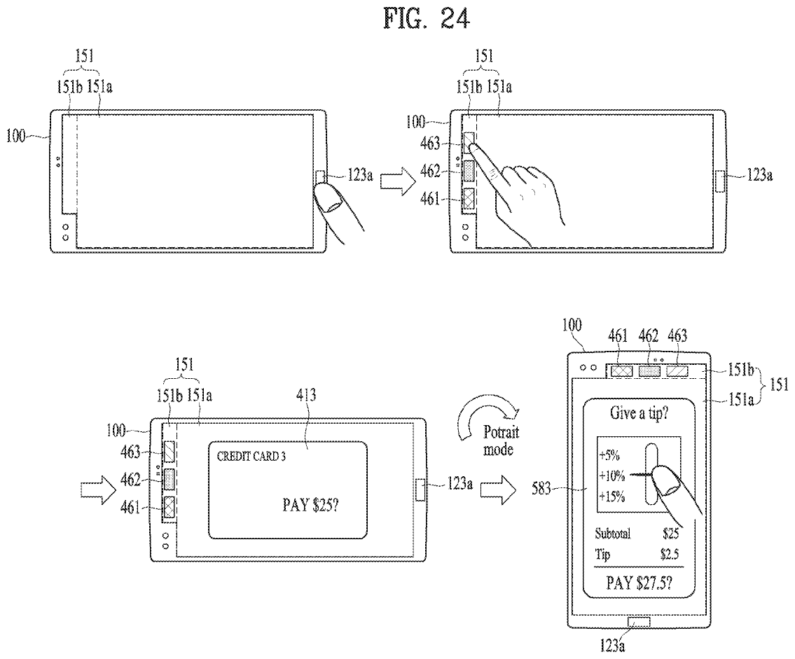

FIG. 24 is an exemplary diagram for a tip payment according to various embodiments of the present invention.

Referring to FIG. 24, the controller 180 of the terminal 100 can recognize a user's fingerprint through the manipulating unit 123a in first mode, e.g., landscape mode. If recognizing the user's fingerprint, the controller 180 can execute a payment function and display a plurality of indicators 461 to 463 on the sub-display region 151b. If obtaining an input of selecting one of a plurality of the indicators 461 to 463 displayed on the sub-display region 151b, the controller 180 can display a third credit card image 413 corresponding to the selected indicator 463 on the main display unit 151a. And, the controller 180 may display an estimated payment amount on the displayed third credit card image 413. Based on a sensing value of the sensing unit 140, the controller 180 of the terminal 100 can recognize that a screen mode of the terminal is switched to a second mode from the first mode. For example, based on a sensing value of the sensing unit 140, the controller 180 can recognize that it is switched to the portrait mode from the landscape mode. If switching to the second mode from the first mode, the controller 180 can display a tip setting window 583 for setting a tip amount that is to be added to a payment using card information of a third credit card corresponding to the displayed third credit card image 413. If obtaining an input of selecting a tip percentage displayed on the tip setting window 583, the controller 180 can make payment to which a tip corresponding to the selected percentage is added. For example, if a tip of 10% is selected, the controller 180 can pay total 27.5 dollars resulting from adding 2.5 dollars that is 10% of 25 dollars of the estimated payment amount. The controller 180 can transmit the card information of the third credit card and the final tip-added amount information to another device to make payment, e.g., the POS 200. Hence, another device, e.g., the POS 200 can make payment based on the transmitted card information and final amount. Thus, the terminal 100 can display an indicator indicating a card on the sub-display region 151b and also display a card image for a selected indicator on the main display 151a. And, in response to a mode switching, the terminal 100 can set details (e.g., tip addition) for payment using card information corresponding to the displayed card image.

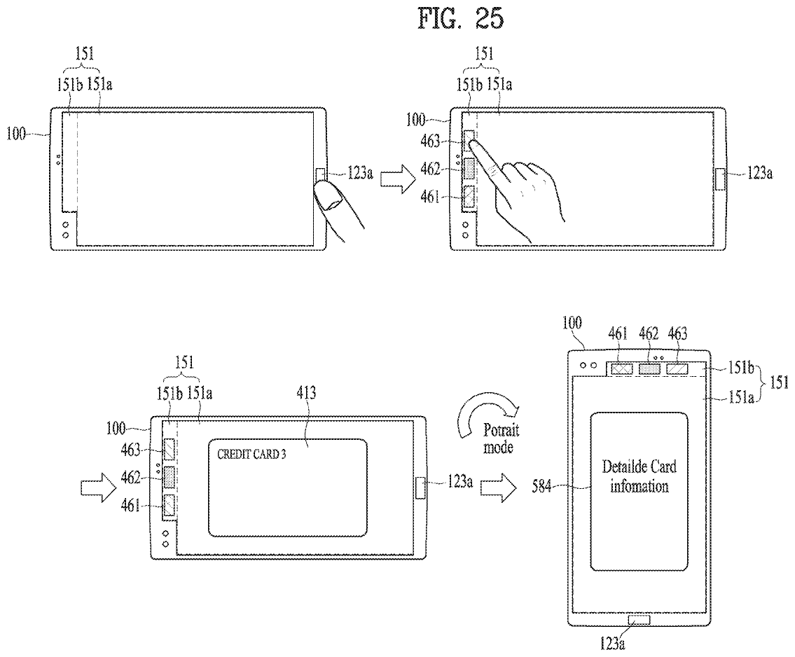

FIG. 25 is an exemplary diagram for a detailed card information display according to various embodiments of the present invention.

Referring to FIG. 25, the controller 180 of the terminal 100 can recognize a user's fingerprint through the manipulating unit 123a in first mode, e.g., landscape mode. If recognizing the user's fingerprint, the controller 180 can execute a payment function and display a plurality of indicators 461 to 463 on the sub-display region 151b. If obtaining an input of selecting one of a plurality of the indicators 461 to 463 displayed on the sub-display region 151b, the controller 180 can display a third credit card image 413 corresponding to the selected indicator 463 on the main display unit 151a. Based on a sensing value of the sensing unit 140, the controller 180 of the terminal 100 can recognize that a screen mode of the terminal is switched to a second mode from the first mode. For example, based on a sensing value of the sensing unit 140, the controller 180 can recognize that it is switched to the portrait mode from the landscape mode. If switching to the second mode from the first mode, the controller 180 can display a detailed card information 584 of a third credit card corresponding to the displayed third credit card image 413 on the main display region 151a. Thus, the terminal 100 can display an indicator indicating a card on the sub-display region 151b and also display a card image for a selected indicator on the main display 151a. And, in response to a mode switching, the terminal 100 can display a detailed card information corresponding to the displayed card image.

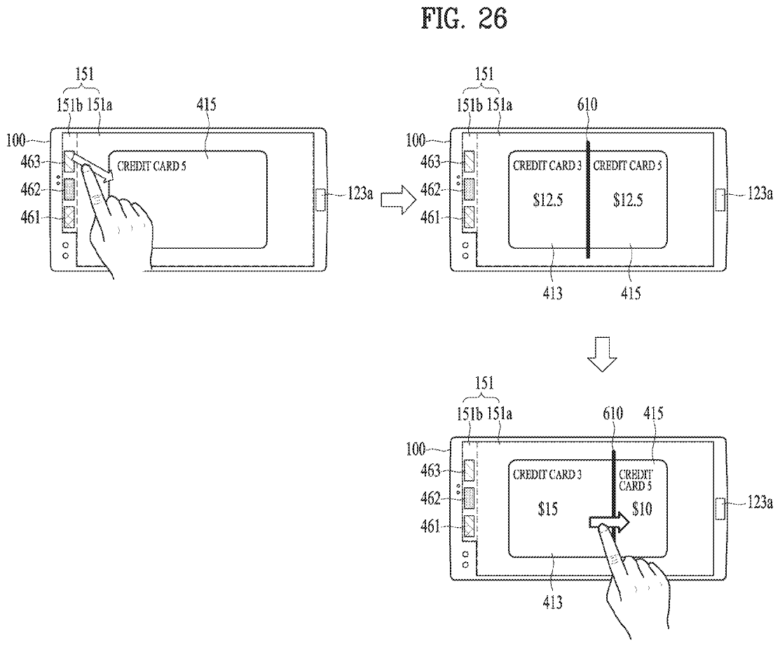

In some implementations, based on an input to a card image displayed on the sub-display region 151b, the terminal 100 may perform a compound payment using a plurality of cards. This is described with reference to FIG. 26.

FIG. 26 is an exemplary diagram for a compound payment according to various embodiments of the present invention.

Referring to FIG. 26, the terminal 100 can display a fifth credit card image 415 on the main display region 151a and also display a plurality of indicators 461 to 463 on the sub-display region 151b. The terminal 100 can obtain an input of dragging & dropping one 463 of a plurality of the indicators 461 to 463 displayed on the sub-display region 151b to the fifth credit card image 415. Hence, the terminal 100 can make a compound payment using a fifth credit card corresponding to the fifth credit card image 415 and a third card corresponding to the dragged & dropped indicator 463. The terminal 100 can display a third card image 413 and the fifth credit card image 415 as a single card on the main display region 151a and also display a payment ratio according to a position of a center line 610 on the card images. For example, if the position of the center line 610 is located in the middle between the third card image 413 and the fifth credit card image 415, the controller 180 can recognize that a payment ratio of the compound payment is 5:5 and display a payment amount ‘12.5 dollars’ on each of the card images in case of making the compound payment for total 25 dollars. And, the controller 180 can adjust the payment ratio of the compound payment according to an input of moving the position of the center line 610. For example, if the center line 610 is located at 6:4 of the third card image 413 and the fifth credit card image 415, the controller 180 can display payment amounts of 15 dollars and 10 dollars on the third card image 413 and the fifth credit card image 415, respectively. Thus, the terminal 100 can make compound payment using a plurality of cards and adjust a payment ratio of the compound payment.

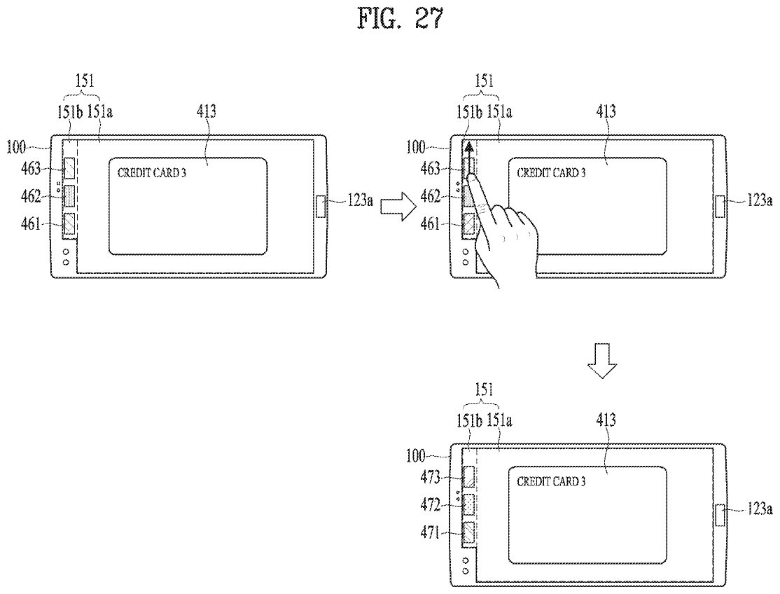

Based on an input to a plurality of card images displayed on the sub-display region 151b, the terminal 100 according to various embodiments can display a plurality of card images included in various categories. This is described with reference to FIG. 27.

FIG. 27 is an exemplary diagram for a card category change display according to various embodiments of the present invention.

Referring to FIG. 27, the terminal 100 can display a third credit card image 413 on the main display region 151a and also display a plurality of indicators 461 to 463 on the sub-display region 151b. Here, a plurality of the displayed indicators 461 to 463 may correspond to first to third credit cards, respectively and be included in a credit card category. The terminal 100 can obtain an input of swiping the sub-display region 151b in one direction. In response to the obtained swipe input, the terminal 100 can display a plurality of indicators, which are included in a category different from that of a plurality of the displayed indicators 461 to 463, on the sub-display region 151b. For example, the terminal 100 can display a plurality of indicators 471 to 473 corresponding to a plurality of accumulative cards included in an accumulative card category on the sub-display region 151b. here, a plurality of the indicators 471 to 473 may correspond to first to third mileage cards, respectively and be included in an accumulative card category. Thus, based on an input to the sub-display region 151b on which a plurality of card images are displayed, the terminal 100 can change a category of card images displayed on the sub-display region 151b. Therefore, a user can select a card image included in a changed category and use a payment function through a card included in the changed category.

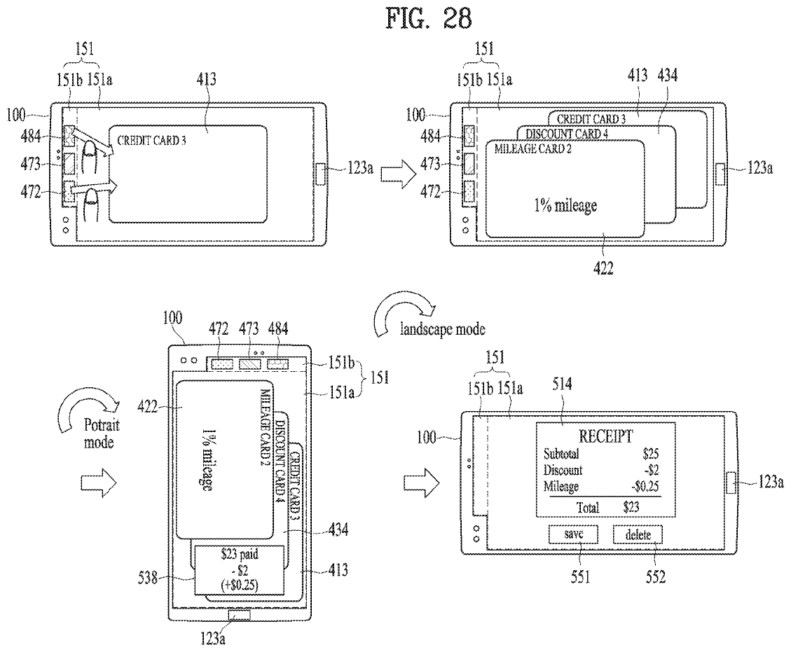

In some implementations, based on an input to a card image displayed on the sub-display region 151b, the terminal 100 can make a compound payment using a plurality of cards included in different categories. This is described with reference to FIG. 28.

FIG. 28 is an exemplary diagram for a payment using a plurality of cards according to various embodiments of the present invention.

Referring to FIG. 28, the terminal 100 can display a third credit card image 413 on the main display region 151a and also display a plurality of indicators 472, 473 and 484 on the sub-display region 151b. The terminal 100 can obtain an input of dragging & dropping the indicator 472 corresponding to a second mileage card and the indicator 484 corresponding to a fourth discount card among a plurality of the indicators 472, 473 and 484 displayed on the sub-display region 151b to the third card image 413. Hence, the terminal 100 can make a compound payment using a third credit card corresponding to the third card image 413, the second mileage card corresponding to the dragged & dropped indicator 472, and the fourth discount card corresponding to the dragged & dropped indicator 484. The terminal 100 can display the third card image 413, a second accumulative card image 422 and a fourth discount image 434 on the main display region 151a. Based on a sensing value of the sensing unit 140, the controller 180 of the terminal 100 can recognize that a screen mode of the terminal is switched to a second mode from a first mode. For example, based on a sensing value of the sensing unit 140, the controller 180 can recognize that it is switched to a portrait mode from a landscape mode. If switching to the second mode from the first mode, the controller 180 can transmit cards informations of the first credit card, the second mileage card and the fourth discount card to another device to make payment, e.g., the POS 200. Hence, another device, e.g., the POS 200 can make payment based on the transmitted card informations. The terminal 100 can display schematic information on the made payment on a payment breakdown window 538. For example, on a prescribed region of the display unit 151, the controller 180 can display that 23 dollars are paid, that 2 dollars are discounted, and that 0.25 dollar is accumulated. Moreover, if recognizing that it is switched to the first mode from the second mode again, the terminal 100 can display detailed information (e.g., receipt) on breakdown of the made payment. As one embodiment, if switching to the landscape mode from the portrait mode again, the terminal 100 can display a receipt 514 on the main display region 151a. Moreover, the controller 180 can display a save button 551 for saving information corresponding to the receipt 514 and a delete button 552 for deleting the information corresponding to the receipt 514 on the display unit 151. Based on an input to the save button 551 or the delete button 552, the terminal 100 can save or delete the information corresponding to the receipt 514. Meanwhile, if there is no input to the save button 551 or the delete button 552 within a predetermined time, the displayed receipt 514 may be removed. Thus, the terminal 100 can display indicators indicating a plurality of cards included in various categories and make payment using a plurality of cards corresponding to selected indicators.

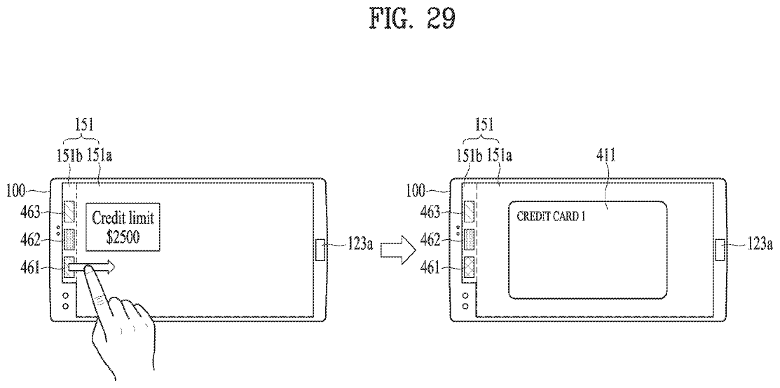

In response to an input to a card image displayed on the sub-display region 151b, the terminal 100 according to various embodiments may display card information of a card corresponding to a selected card image. This is described with reference to FIG. 29.

FIG. 29 is an exemplary diagram for a card information display according to various embodiments of the present invention.

Referring to FIG. 29, the terminal 100 can display a plurality of indicators 461 to 463 on the sub-display region 151b. The terminal 100 can obtain an input of dragging one 461 of a plurality of the indicators 461 to 463 displayed on the sub-display region 151b. If a dragged distance of the selected indicator 461 is equal to or smaller than a reference distance, the controller 180 can display a payment limit of a first credit card corresponding to the selected indicator 461. If a dragged distance of the selected indicator 461 is greater than the reference distance, the controller 180 can display a first credit card image 411 on the main display region 151a.

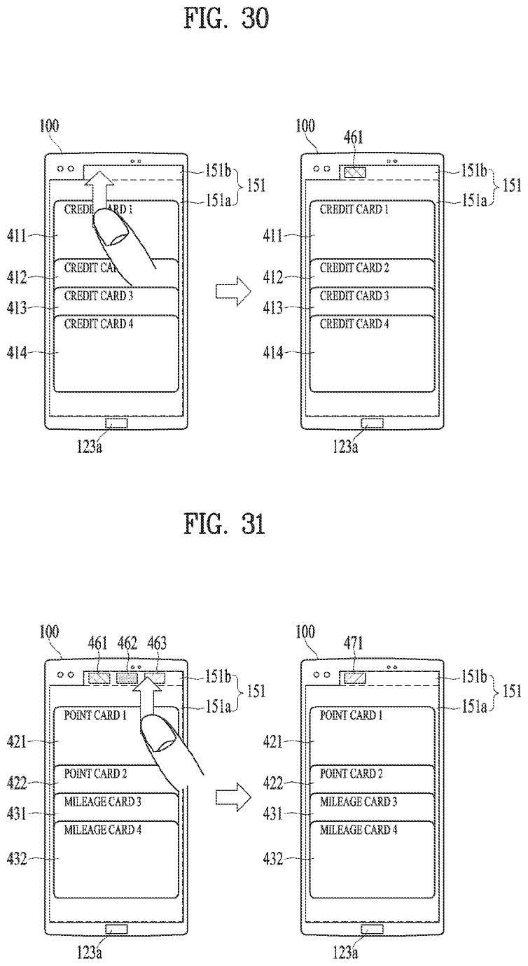

The terminal 100 according to various embodiments can display a card image of a selected card on the sub-display region 151b. This is described with reference to FIGS. 30 to 34.

FIG. 30 and FIG. 31 are exemplary diagrams for a card image arrangement in a sub-display region according to various embodiments of the present invention.

Referring to FIG. 30, the terminal 100 can display a plurality of card images, e.g., first to fourth credit card images 411 to 414 on the main display region 151a. The terminal 100 can obtain an input of dragging & dropping the first credit card image 411 among a plurality of the credit card images 411 to 414 displayed on the main display region 151a to the sub-display region 151b. The terminal 100 can display an indicator 461 corresponding to the dragged & dropped first credit card image 411 on the sub-display region 151b. Hence, the terminal 100 can display the indicator 461 corresponding to a first credit card on the sub-display region 151b. Thus, the terminal 100 can display a card image of a selected card on the sub-display region 151b.

Referring to FIG. 31, the terminal 100 can display a plurality of card images, e.g., first to fourth credit card images 421 to 424 on the main display region 151a and also display a plurality of indicators 461 to 463 on the sub-display region 151b. Here, a plurality of the indicators 461 to 463 displayed on the sub-display region 151b may correspond to first to third credit cards, respectively. The terminal 100 can obtain an input of dragging & dropping the first point card image 421 among a plurality of the point cards displayed on the main display region 151a to the sub-display region 151b. If the first point card image 421 belonging to a point card category different from a credit card category to which a plurality of the indicators 461 to 463 displayed on the sub-display region 151b belong is dragged & dropped to the sub-display region 151b, the terminal 100 can remove the indicators 461 to 463 displayed on the sub-display region 151b and display the indicator 471 corresponding to the first point card on the sub-display region 151b. Thus, when displaying a card image corresponding to a card belonging to a category different from that of a card image previously displayed on the sub-display region 151b, the terminal 100 can remove the previously displayed card image and then display a card image corresponding to a selected card on the sub-display region 151b.

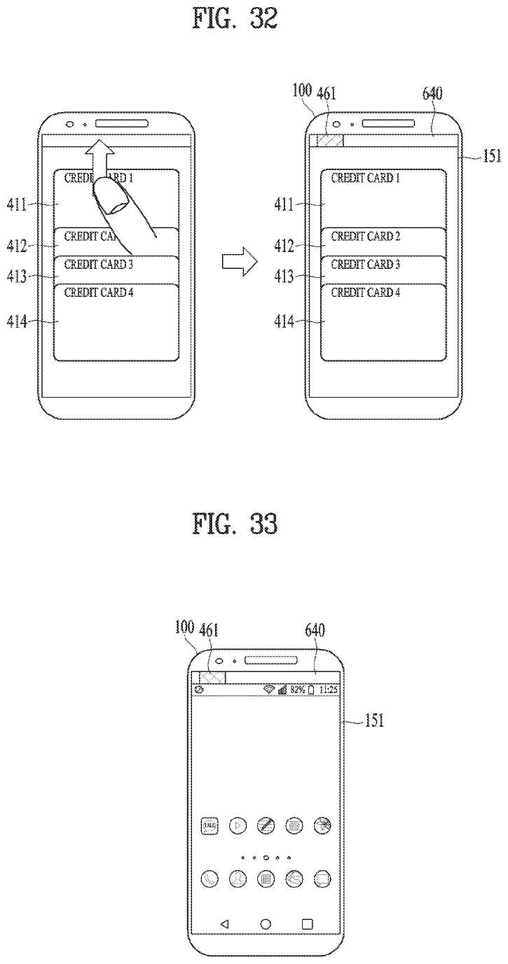

In some implementations, although a sub-display region is not provided, the terminal 100 according to various embodiments can display a card image on a prescribed region. This is described with reference to FIGS. 32 to 34.

FIG. 32 is an exemplary diagram for a card image display in a prescribed partitioned region according to various embodiments of the present invention.

Referring to FIG. 32, the terminal 100 can display a plurality of card images, e.g., first to fourth credit card images 411 to 414 on the display unit 151. The terminal 100 can obtain an input of dragging & dropping the first credit card image 411 to a prescribed top end region of the display unit 151. Here, the prescribed top end region of the display unit 151 may include a region corresponding to a notification bar displaying notification information. The terminal 100 can display a partitioned region 640 for displaying a card image on the prescribed top end region of the display unit 151 and also display an indicator 461 corresponding to a first credit card on the partitioned region 640. Thus, if failing to have a plurality of displays or a plurality of display regions, the terminal 100 can display a card image on a prescribed region of a display region.

FIG. 33 is a diagram showing a partitioned region maintained screen according to various embodiments of the present invention.

Referring to FIG. 33, the terminal 100 can display a home screen, in which a partitioned region 640 is maintained, on the display unit 151. The terminal 100 can display at least one card image on the partitioned region 640. For example, the terminal 100 can display an indicator 461 corresponding to a first credit card on the partitioned region 640. Even if various applications are launched, the terminal 100 can display the partitioned region 640 and display at least one card image on the displayed partitioned region 640.

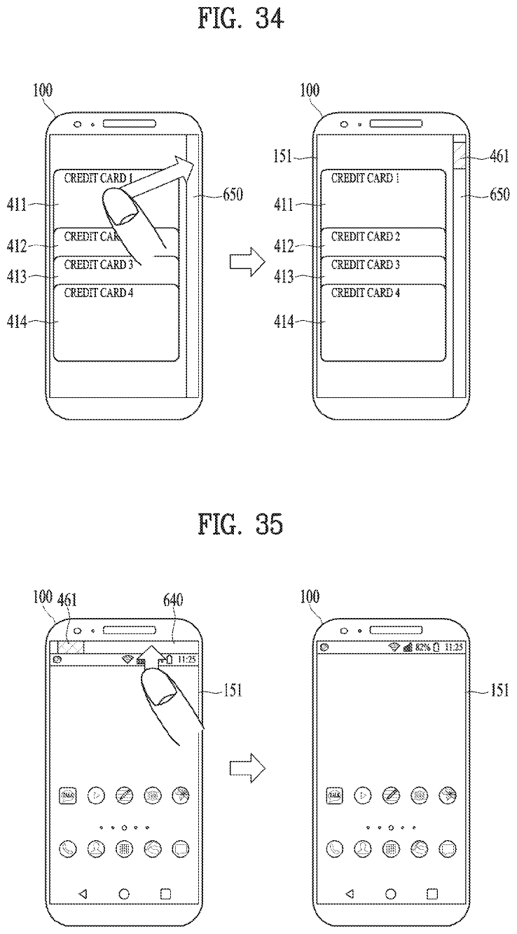

FIG. 34 is an exemplary diagram for a card image display on a prescribed partitioned region according to various embodiments of the present invention.

Referring to FIG. 34, the terminal 100 can display a plurality of card images, e.g., first to fourth credit card images 411 to 414 on the display unit 151. The terminal 100 can obtain an input of dragging & dropping the first credit card image 411 to a prescribed lateral side region of the display unit 151. Here, the prescribed lateral side region of the display unit 151 may include one lateral side region of a display or include a planar or curved surface. The terminal 100 can display a partitioned region 650 for displaying a card image on the prescribed lateral side region of the display unit 151 and also display an indicator 461 corresponding to a first credit card on the partitioned region 650. Thus, if failing to have a plurality of displays or a plurality of display regions, the terminal 100 can display a card image on a prescribed region of a display region.

In some implementations, based on an input to a partitioned region on which a card image is displayed, the terminal 100 can remove the partitioned region. This is described with reference to FIG. 35.

FIG. 35 is an exemplary diagram for a partitioned region removal according to various embodiments of the present invention.

Referring to FIG. 35, the terminal 100 can display a partitioned region 640 for displaying a card image on a prescribed top end region of the display unit 151 and also display an indicator 461 corresponding to a first card image on the partitioned region 640. The terminal 100 can obtain an input of dragging the partitioned region in a top direction and then remove the partitioned region 640 in response to the obtained input. Thus, the terminal 100 can remove a partitioned region based on an input to a partitioned region.

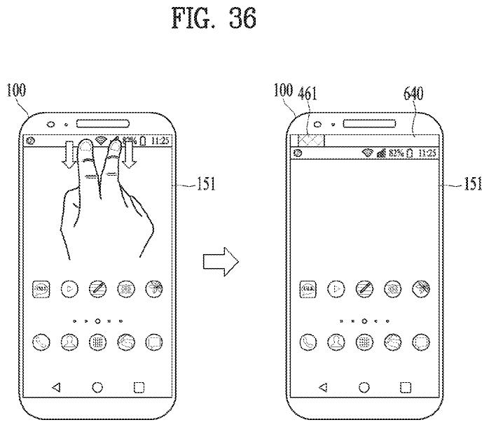

FIG. 36 is an exemplary diagram for a partitioned region display according to various embodiments of the present invention.

Referring to FIG. 36, the terminal 100 can obtain an input of multiply touching & dragging a prescribed top end region of the display unit 151 in a bottom direction. The terminal 100 can display a partitioned region 640, to which the multi-touch & drag is inputted, on the prescribed top end region of the display unit 151. And, the terminal 100 can display an indicator 461 corresponding to at least one card image, e.g., a first credit card. Thus, the terminal 100 can display a partitioned region in response to an input.

The above-described present invention can be implemented in a program recorded medium as computer-readable codes. The computer-readable media may include all kinds of recording devices in which data readable by a computer system are stored. The computer-readable media may include ROM, RAM, CD-ROM, magnetic tapes, floppy discs, optical data storage devices, and the like for example and also include carrier-wave type implementations (e.g., transmission via Internet). Further, the computer may include the controller 180 of the terminal. Therefore, this description is intended to be illustrative, and not to limit the scope of the claims. Thus, it is intended that the present invention covers the modifications and variations of this invention provided they come within the scope of the appended claims and their equivalents.

What is claimed is:

1. A method of operating a terminal, the method comprising:
executing a payment function in first screen mode having a terminal's screen direction set to a first direction;
displaying a default payment card image corresponding to the executed payment function;
transmitting card information corresponding to the displayed default payment card image;
recognizing that the first screen mode is switched to a second screen mode having the terminal's screen direction set to a second direction; and
performing an additional function related to a payment according to the transmitted card information in the second screen mode.

2. The method of claim 1, the performing the additional function related to the payment, comprising outputting a payment breakdown according to the transmitted card information.

3. The method of claim 1, the performing the additional function related to the payment, comprising performing an additional payment further including at least one of accumulation and discount related to the payment.

4. The method of claim 1, the performing the additional function related to the payment, comprising sharing information on a payment breakdown according to the transmitted card information.

5. The method of claim 1, wherein the first screen mode is a portrait mode and wherein the second screen mode is a landscape mode.

6. A method of operating a terminal, the method comprising:
obtaining an input of selecting at least one card image displayed on a sub-display region in first screen mode having a terminal's screen direction set to a first direction;
displaying card information corresponding to the selected at least one card image on a main display region;
recognizing that the first screen mode is switched to a second screen mode having the terminal's screen direction set to a second direction; and
performing a payment function related to the card information displayed on the main display region in the second screen mode.

7. The method of claim 6, the performing the payment function related to the card information, comprising transmitting the card information to a different device.

8. The method of claim 6, the performing the payment function related to the card information, comprising:
obtaining a detailed setting input for a payment using the card information; and
performing the payment according to the obtained detailed setting input.

9. The method of claim 6, the performing the payment function related to the card information, comprising outputting a payment breakdown related to the card information.

10. The method of claim 6, wherein the first screen mode is a landscape mode and wherein the second screen mode is a portrait mode.

11. A terminal, comprising:
a memory;
a display unit;
a wireless communication unit transmitting card information;
a sensing unit sensing a terminal's screen direction; and
a controller configured to:
execute a payment function in first screen mode having the terminal's screen direction set to a first direction,
display a default payment card image corresponding to the executed payment function on the display unit,
transmit card information corresponding to the displayed default payment card image through the wireless communication unit,
recognize that the first screen mode is switched to a second screen mode having the terminal's screen direction set to a second direction based on a sensing value of the sensing unit, and
perform an additional function related to a payment according to the transmitted card information in the second screen mode.

12. The terminal of claim 11, wherein the controller outputs a payment breakdown according to the transmitted card information in the second screen mode.

13. The terminal of claim 11, wherein the controller performs an additional payment further including at least one of accumulation and discount related to the payment in the second screen mode.

14. The terminal of claim 11, wherein the controller shares information on a payment breakdown according to the transmitted card information.

15. The terminal of claim 11, wherein the first screen mode is a portrait mode and wherein the second screen mode is a landscape mode.

16. A terminal, comprising:
a memory;
a display unit including a main display region and a sub-display region;
a wireless communication unit transmitting card information;
a sensing unit sensing a terminal's screen direction; and
a controller configured to:
obtain an input of selecting at least one card image displayed on the sub-display region in first screen mode having a terminal's screen direction set to a first direction, display card information corresponding to the selected at least one card image on the main display region,
recognize that the first screen mode is switched to a second screen mode having the terminal's screen direction set to a second direction based on a sensing value of the sensing unit, and
perform a payment function related to the card information displayed on the main display region in the second screen mode.

17. The terminal of claim 16, wherein the controller transmits the card information to a different device through the wireless communication unit in the second screen mode.

18. The terminal of claim 16, wherein the controller obtains a detailed setting input for a payment using the card information in the second screen mode and performs the payment according to the obtained detailed setting input.

19. The terminal of claim 16, wherein the controller outputs a payment breakdown related to the card information in the second screen mode.

20. The terminal of claim 16, wherein the first screen mode is a landscape mode and wherein the second screen mode is a portrait mode.
